(19) United States
(12) Patent Application Publication
(10) Pub. No.: US 2013/0144942 A1
(43) Pub. Date: Jun. 6, 2013

(54) SESSION PERSISTENCE FOR ACCESSING TEXTSITES

(71) Applicants: Gopi Krishnan Nambiar, Bangalore (IN); Pranay Airan, Bangalore (IN)

(72) Inventors: Gopi Krishnan Nambiar, Bangalore (IN); Pranay Airan, Bangalore (IN)

(21) Appl. No.: 13/756,130

(22) Filed: Jan. 31, 2013

Related U.S. Application Data
(63) Continuation-in-part of application No. 12/728,169, filed on Mar. 19, 2010.

(30) Foreign Application Priority Data
Jan. 30, 2013 (IN) 491/KOL/2013

(51) Int. Cl. H04L 29/06

(52) U.S. Cl. CPC H04L 67/42
USPC 709/203

(57) ABSTRACT

A method for accessing content during a client server application session comprises receiving a first request to access the content using a first network protocol, the first request comprising a first user identifier, generating a user data item for including in a user data set of the client server application session, wherein the user data set is tagged with the first user identifier, receiving a second request to access the content using a second network protocol, wherein the second request comprises a second user identifier; analyzing the second request to obtain the first user identifier; retrieving the user data item from the user data set based on the first user identifier, and providing a requested portion of the content based on the user data item.

### CROSS-REFERENCE TO RELATED APPLICATIONS

This application is a continuation-in-part (CIP) of U.S. patent application Ser. No. 12/728,169 filed on Mar. 19, 2010. Accordingly, this application claims benefit under 35 U.S.C. §120 to U.S. patent application Ser. No. 12/728,169. Accordingly, U.S. patent application Ser. No. 12/728,169 is hereby incorporated by reference in its entirety.

This application claims priority to Indian Patent Application No. 491/KOL/2013, filed on Jan. 30, 2013, and entitled: “SESSION PERSISTENCE FOR ACCESSING TEXTSITES.” Accordingly, this application claims priority to Indian Patent Application No. 491/KOL/2013 under 35 U.S.C. §119(a). Indian Patent Application No. 491/KOL/2013 is hereby incorporated by reference in its entirety.

This application is related to copending U.S. patent application Ser. No. YYYY (Attorney Docket No. 37202/530001), filed on Jan. 31, 2013, and entitled “A MOBILE APPLICATION USING TEXT MESSAGING SERVICE PROTOCOL OR OTHER NETWORK PROTOCOL REQUIRING A DATA PLAN,” which is also assigned to the assignee of the present application, the subject matter of which is incorporated by reference herein.

### BACKGROUND

Today's mobile devices, such as smart phones, allow users to browse the Internet from any location to obtain information on demand. As long as a user is in an area with the proper telecommunication network and subscribes to a data plan, the user is provided with access to the Internet for web browsing to obtain information such as phone numbers for service providers, map out a particular destination location, and obtain information relevant to the user's current or next activity. However, there are often instances in which a user wishes to access only limited information for a quick answer to a question (e.g., what are the next available show times for a particular movie?). In this scenario, browsing the website for the movie theater or a service provider website that provides movie show times, such as Fandango, may be cumbersome on the mobile device. Specifically, loading all the graphics and advertisements associated with websites on a mobile device can take additional time. In other words, the entire website may provide too much data to navigate through when a user desires only a specific piece of information. In addition, for mobile device users who do not subscribe to a data plan for browsing the Internet, are in an area without the proper telecommunication network, or do not have browsing capability on their mobile device, accessing such information on demand is not possible.

With the growth in smartphone applications market, more and more applications depend on Internet connection to function properly. However, especially in emerging market economies, when a potential user of an application does not have a data plan or other Internet connection, the application cannot effectively be used.

### SUMMARY

In general, in one aspect, the invention relates to a method for accessing content during a client server application session. The method comprises: receiving, during the client server application session and from a user client device, a first request to access the content using a first network protocol, wherein the first request comprises a first user identifier; generating, in response to receiving the first request and by a processor of a computer server storing the content, a user data item for including in a user data set of the client server application session, wherein the user data set is tagged with the first user identifier; receiving, during the client server application session and from the user client device, a second request to access the content using a second network protocol, wherein the second request comprises a second user identifier; analyzing, by the computer processor and based on an association between the first user identifier and the second user identifier, the second request to obtain the first user identifier; retrieving, by the computer processor and in response to the analyzing, the user data item from the user data set based on the first user identifier; and providing, in response to receiving the second request, a requested portion of the content based on the user data item.

In general, in one aspect, the invention relates to a system accessing content during a client server application session. The system comprises a repository storing the content and a user data set of the client server application session; a processor; and memory storing instructions when executed by the processor comprising functionalities to: receive, during the client server application session and from a user client device, a first request to access the content using a first network protocol, wherein the first request comprises a first user identifier; generate, in response to receiving the first request, a user data item for including in the user data set, wherein the user data set is tagged with the first user identifier; receive, during the client server application session and from the user client device, a second request to access the content using a second network protocol, wherein the second request comprises a second user identifier; analyze, based on an association between the first user identifier and the second user identifier, the second request to obtain the first user identifier; retrieve, in response to the analyzing, the user data item from the user data set based on the first user identifier; and provide, in response to receiving the second request and to the client device, a requested portion of the content based on the user data item.

In general, in one aspect, the invention relates to a non-transitory computer readable storage medium comprising software instructions for accessing content during a client server application session. When executed, the software instructions comprise functionality to: receive, during the client server application session and from a user client device, a first request to access the content using a first network protocol, wherein the first request comprises a first user identifier; generate, in response to receiving the first request, a user data item for including in a user data set of the client server application session, wherein the user data set is tagged with the first user identifier; receive, during the client server application session and from the user client device, a second request to access the content using a second network protocol, wherein the second request comprises a second user identifier; analyze, based on an association between the first user identifier and the second user identifier, the second request to obtain the first user identifier; retrieve, in response to the analyzing, the user data item from the user data set based on the first user identifier; and provide, in response to receiving the second request, a requested portion of the content based on the user data item.

Other aspects of the invention will be apparent from the following description and the appended claims.

### BRIEF DESCRIPTION OF DRAWINGS

FIGS. 1A and 1B show block diagrams of a system in accordance with one or more embodiments of the invention.

FIGS. 2A and 2B show flow charts of methods in accordance with one or more embodiments of the invention.

FIGS. 3A-3J show screenshots of a first example in accordance with one or more embodiments of the invention.

FIGS. 4A-4F show screenshots of a second example in accordance with one or more embodiments of the invention.

FIG. 5 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for maintaining session persistence for accessing textsites using text messaging service (TMS) and other network protocol. The TMS may be, for example, Short Messaging Service (SMS), Multi-media Messaging Service (MMS), Enhanced Messaging Service (EMS), or any other text messaging service which is now known or later developed. In one or more embodiments of the invention, a textsite is one or more pages of content that is made globally accessible via a TMS. Similar to websites known today, which are made globally accessible via the Internet, a textsite includes a homepage and one or more text pages that are hierarchically and/or organizationally linked to the homepage for browsing information contained in one or more text pages of the textsite. In one or more embodiments, the textsite may also be accessible using additional network protocols (e.g., HTTP) other than the TMS. In one or more embodiments, user data created while accessing the textsite is persistent throughout a user session, before and after changing from the TMS protocol to the other network protocol, and vice versa.

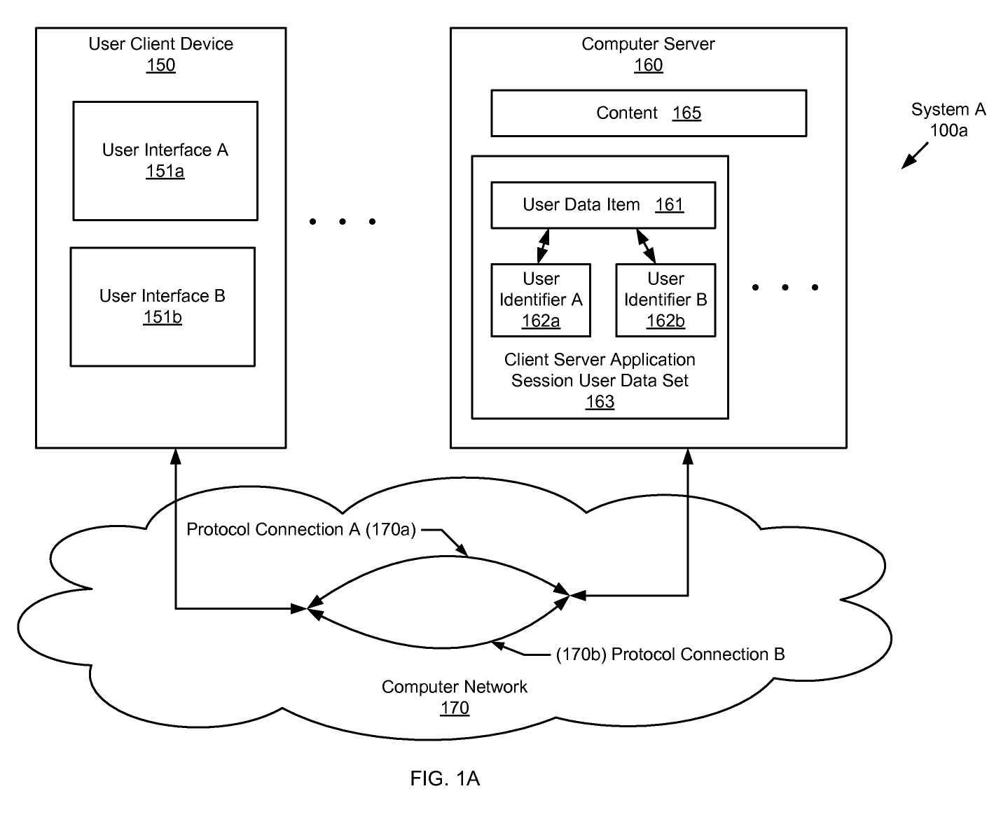

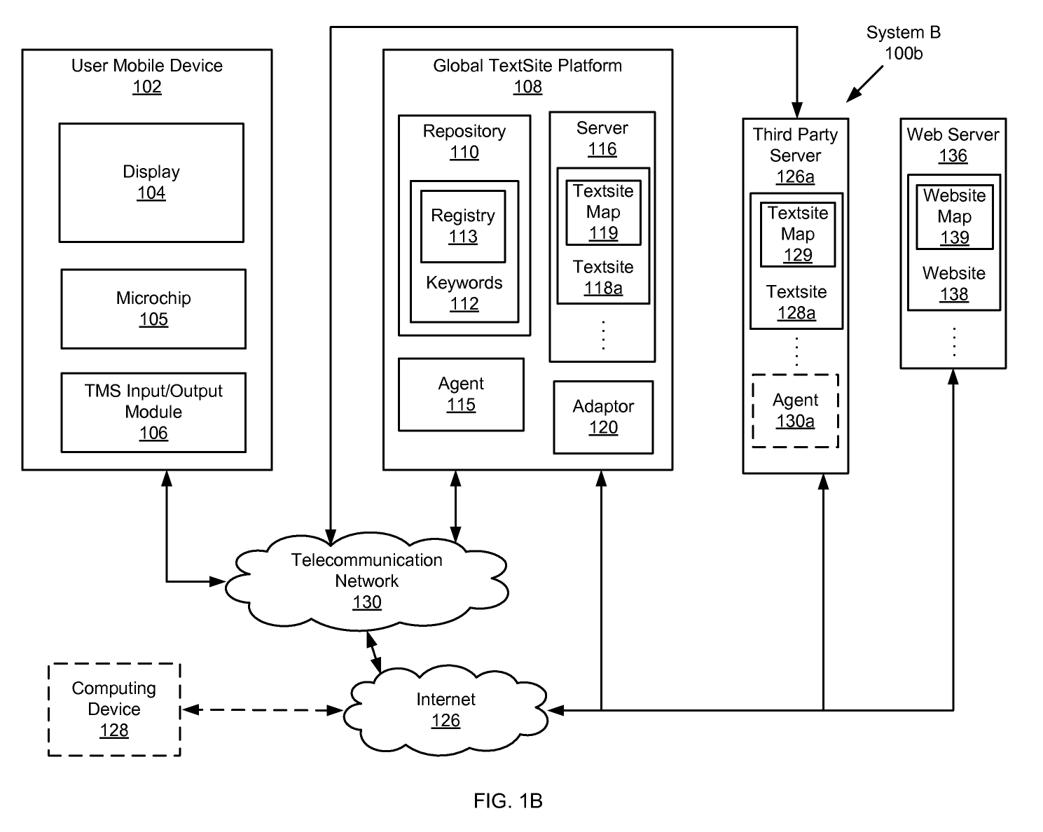

FIG. 1A shows a block diagram of a system (100a) for accessing content during a client server application session in accordance with one or more embodiments of the invention. Specifically, the system (100a) includes a user client device (150) and a computer server (160) coupled via a computer network (170). In one or more embodiments of the invention, one or more of the modules and elements shown in FIG. 1A may be omitted, repeated, and/or substituted. Accordingly, embodiments of the invention should not be considered limited to the specific arrangements of modules shown in FIG. 1A.

In one or more embodiments of the invention, the computer network (170) may include a cellular phone network, a wide area network, a local area network, a public switched telephone network (PSTN), or any other suitable network that facilitates the exchange of messages from one part of the network to another. In one or more embodiments, the computer network (170) is coupled to or overlap with the Internet. In one or more embodiments, one or more protocol connections (e.g., protocol connection A (170a), protocol connection B (170b)) may be established between the user client device (150) and the computer server (160) via the computer network (170) to support data communication (e.g., sending and receiving messages or other data elements). For example, the protocol connection A (170a) may use the HTTP protocol, while the protocol connection B (170b) may use the text messaging service (TMS) protocol. The HTTP protocol and the TMS protocol are data communication protocols. In one or more embodiments, the protocol connection A (170a) (e.g., HTTP connection) may be connected (i.e., established) or disconnected (i.e., torn down), as directed by a user, according to specifics of the data communication protocol used. From time to time, the protocol connection A (170a) may be lost (i.e., disconnected without being directed by the user) resulting in a connection loss event. In one or more embodiments, the protocol connection B (170b) (e.g., TMS connection) may be statically connected.

In one or more embodiments of the invention, each of the computer server (160) and the user client device (150) may be any computing device configured with computing, data storage, and network communication functionalities. Generally, the computer server (160) is configured with high performance computing capability and large amount of data storage capacity to support multiple user client devices (e.g., user client device (150)) in a client server application environment. For example, the content (165) stored in the computer server (160) may be accessed by multiple user client devices (e.g., user client device (150)) in a concurrent fashion. In one or more embodiments, the content (165) may include information stored in a repository (not shown) of the computer server (160), information dynamically generated by the computer server (160), and/or information dynamically retrieved by the computer server (160) from other sources (not shown) that are accessible via the computer network (170a).

In one or more embodiments, the term “client server application session” refers to a sequence of activities between a particular user client device (e.g., user client device (150)) and the computer server (160). For example, the sequence of activities of a client server application session may be in-between a user log-in and log-out events, within a pre-determined time period, terminated by a system time-out event, etc. In one or more embodiments, the sequence of activities of a client server application session includes requests from the user client device (150) to access the content (165) and the corresponding responses from the computer server (160) to return the requested portions of the content (165).

To facilitate multiple concurrent accesses to resources (e.g., content (165) and computing resources for retrieving requested portions thereof) of the computer server (160) by different user client devices, user data items generated and/or otherwise used during separate client server application sessions are organized as separate client server application session user data sets (e.g., client server application session user data set (163)). In one or more embodiments, each client server application session user data set, or any user data item included therein, is tagged by a user identifier to differentiate among multiple concurrent client server application sessions associated with different user client devices. For example, the client server application session user data set (163) includes a user data item (161) that is generated and/or otherwise used during a client server application session of the user client device (150). Accordingly, the client server application session user data set (163) and/or the user data item (161) is tagged by a user identifier of the user client device (150). For example, the user identifier A (162a) is associated with communication between the user client device (150) and the computer server (160) using a network protocol A (e.g., HTTP) via the protocol connection A (170a). Similarly, the user identifier B (162b) is associated with communication between the user client device (150) and the computer server (160) using a network protocol B (e.g., TMS) via the protocol connection B (170b). In one or more embodiments, the user identifier A (162a) is extracted, encrypted, or otherwise derived from the user identifier B (162b). In one or more embodiments, the user identifier B (162b) is extracted, encrypted, or otherwise derived from the user identifier A (162a). In one or more embodiments, the user identifier A (162a) is the same as the user identifier B (162b). In one or more embodiments, same as the content (165), the client server application session user data set (163) is also stored in the repository (not shown) of the computer server (160).

To present the requested portion of the content (165) returned from the computer server (160) to a user, the user client device (150) is configured with user interface functionality, such as the user interface A (151a) and the user interface B (151b). For example, the user interface A (151a) is associated with communication between the user client device (150) and the computer server (160) using the network protocol A (e.g., HTTP) via the protocol connection A (170a). Similarly, the user interface B (151b) is associated with communication between the user client device (150) and the computer server (160) using the network protocol B (e.g., TMS) via the protocol connection B (170b). In one or more embodiments, the user interface A (151a) is a subset of and/or derived from the user interface B (151b). In one or more embodiments, the user interface B (151b) is a subset of and/or derived from the user interface A (151a). In one or more embodiments, the user interface A (151a) and the user interface B (151b) are integrated as a single user interface.

In one or more embodiments of the invention, the content (165) is accessed via an application (not shown) executing on the computer server (160). In an example of such embodiments, the client server application user data set (163) may include user configuration settings of the application (not shown). In particular, the user data item (161) may be one of the user configuration settings. An example of the application includes the agent (115) and/or the adaptor (120) described in reference to FIG. 1B below.

In one or more embodiments of the invention, the client server application session user data set (163) may include a set of dynamically assigned links for navigating the textsite (not shown). In particular, the user data item (161) may be one of these dynamically assigned links for navigating the textsite (not shown). Additional details of the textsite (not shown) and navigating thereof are described in reference to FIGS. 1B, 2B, and 3A-3J.

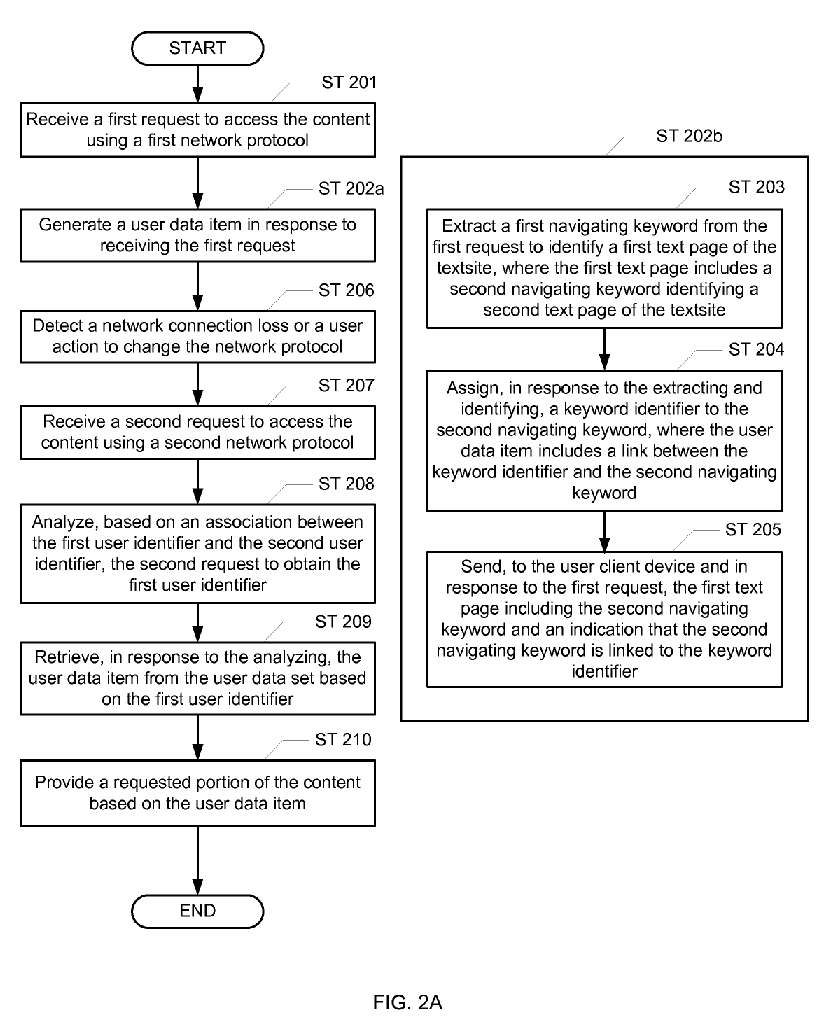

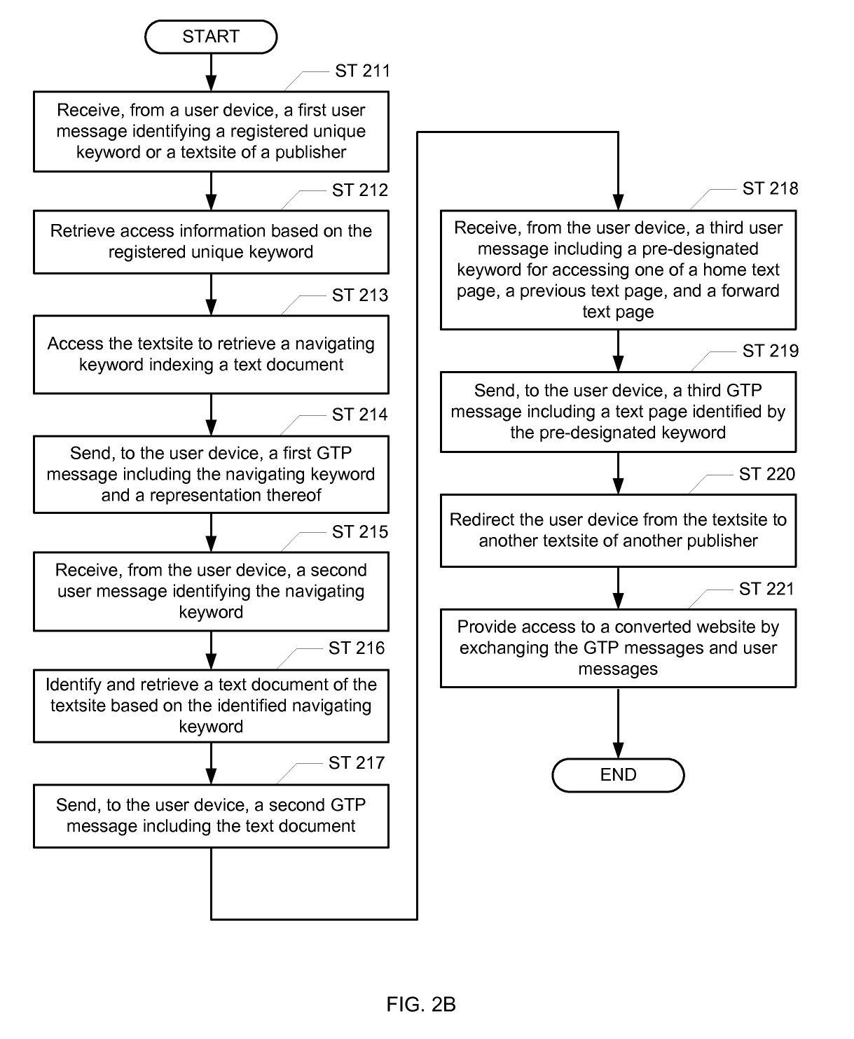

In one or more embodiments, a portion of the sequence of activities in a client server application session may be conducted using the network protocol A (e.g., HTTP) via the protocol connection A (170a) while another portion of the sequence of activities may be conducted using the network protocol B (e.g., TMS) via the protocol connection B (170b). For example, the sequence of activities may initially be conducted via the established protocol connection A (170a) with HTTP protocol until a connection loss of the protocol connection A (170a) is detected. Subsequently, the protocol connection B (170b) with TMS protocol is used as a back up to continue conducting the remainder of the sequence of activities. In another example, the computer network (170) includes a cellular phone network where usage of the protocol connection A (170a) with HTTP protocol incurs additional service fee charge under a data plan offered by a network service provider. In this example, the sequence of activities may initially be conducted using the protocol connection A (170a) with HTTP protocol until the user decides to switch to using the protocol connection B (170b) with TMS protocol to conserve bandwidth usage metered according to the data plan. In one or more embodiments where multiple network protocols are used, the aforementioned examples of the user data item (161) are persistent throughout the client server application session regardless of which protocol connection and network protocol is used. In other words, the aforementioned user configuration setting of the application executing on the computer server (160), and/or the dynamically assigned link for navigating the textsite remains in effect regardless of which protocol connection/network protocol is used to access the content (165). Additional details of session persistence for accessing the content (165) during a client server application session between the user client device (150) and the computer server (160) are described in reference to FIG. 2A and FIGS. 4A-5F below.

FIG. 1B shows a block diagram of a system (100b) for accessing content from a textsite in accordance with one or more embodiments of the invention. Specifically, FIG. 1B shows the global textsite platform (GTP) (108), a user mobile device (102), and a computing device (128) coupled via the telecommunication network (130) and/or the Internet (126). In one or more embodiments of the invention, the system (100b) is an example of the system (100a) depicted in FIG. 1A above. In one or more embodiments, the protocol connection A (170a) and the protocol connection B (170b), depicted in FIG. 1 above, are established via the Internet (126) and/or the telecommunication network (130). Similarly, the user mobile device (102) and the server (116) of the GTP (108) are examples of the user client device (150) and the computer server (160), respectively, depicted in FIG. 1A above. Further, within the GTP (108), the textsite (118a) and at least a portion of the keywords (112) are examples of the content (165) and the client server application session user data set (163), respectively, depicted in FIG. 1A above. In one or more embodiments of the invention, one or more of the modules and elements shown in FIG. 1B may be omitted, repeated, and/or substituted. Accordingly, embodiments of the invention should not be considered limited to the specific arrangements of modules shown in FIG. 1B.

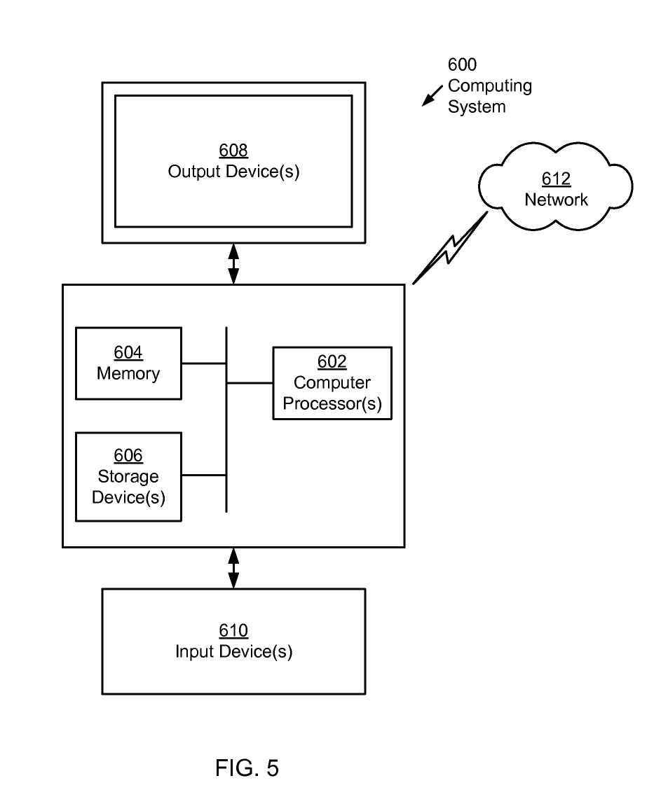

In one or more embodiments of the invention, the global textsite platform (108) executes on one or more computing device(s) (e.g., a server, a computer system as shown in FIG. 5 and described below, etc.) and may be hosted by an entity, such as a corporation. In one or more embodiments of the invention, the global textsite platform (108) is associated with a platform syntax that is specific to the global textsite platform (108) and facilitates communication via a TMS. In one or more embodiments of the invention, the global textsite platform (108) may be associated with different unique phone numbers or codes corresponding to each different geographic location. Alternatively, a single, unique global number/code may be associated with the global textsite platform (108). In one or more embodiments of the invention, the global textsite platform (108) includes a repository (110) for storing keywords (112), a server (116) configured to host a plurality of textsites (e.g., textsite (118a)), an agent (115), and an adaptor (120). Those skilled in the art will appreciate that the server (116) may be any computing device with a large storage capacity.

The repository (110) may be any datastore (flat file, hierarchical file, relational database, enterprise-wide database, etc.) capable of storing data, regardless where or in what form the data originates. Keywords (112) may be reserved or pre-designated keywords maintained by the platform as part of the platform syntax, and publisher keywords that are registered by publishers for each textsite authored by a publisher. In one or more embodiments of the invention, pre-designated keywords and publisher registered keywords are unique. That is, no two keywords from the group of keywords that are pre-designated as platform syntax or the group of keywords provided by a publisher, are allowed to be identical. In fact, in one or more embodiments of the invention, the keywords (112) are closely controlled by the global textsite platform (108) in an effort to eliminate duplicates. Navigating keywords, which a publisher defines for a textsite that is associated with a unique registered keyword, are also used. Navigating keywords are not required to be unique. For example, two distinct publishers with distinct registered keywords representing a first and a second textsite may use the same navigating keyword for different text pages associated with the first and second textsites.

In one or more embodiments, a portion of the keywords (112) is organized as a registry (113) storing a number of registered unique keywords each used as a site identifier and associated with metadata describing a mechanism for accessing corresponding site content, such as content stored in the textsite (118a), etc. In one or more embodiments, the registered unique keywords (i.e., used as site identifiers) are registered by textsite content publishers with relevant information processed into associated metadata. In one or more embodiments, the textsite (118a) may be hosted by the global textsite platform (108) on behalf of a first publisher or may be an in-house textsite maintained by the global textsite platform (108). In such embodiments, the metadata associated with the registered unique keyword (i.e., used as site identifiers) includes an internal link to the textsite (118a) within the global textsite platform (108).

In one or more embodiments, the textsite (128a) is published by a second publisher that has registered with the global textsite platform (108) but is hosted on a separate third party server (126a). In such embodiments, the metadata associated with the registered unique keyword (i.e., used as site identifier) includes an access path for the global textsite platform (108) to access the third party server (126a) via the telecommunication network (230) and/or the Internet (126). In one or more embodiments, the third party server (126a) may include agent (130a) configured with similar functionalities as those of the agent (115). For example, the agent (130a) may be provided to an operator of the third party server (126a) by an operator of the GTP (108) under a pre-determined business agreement (e.g., a licensing agreement).

In one or more embodiments, contents of the website (138) are converted by the global textsite platform (108) to be accessible to a user via TMS. In such embodiments, the metadata associated with the registered unique keyword includes an access path for the global textsite platform (108) to access the web server (136) via the Internet (226) and identifies whether the contents of the website (138), or a portion thereof, are converted dynamically (i.e., on demand) or statically (i.e., pre-converted and stored).

Generally, a publisher may be any person or entity that publishes information/content of a textsite (e.g., textsite (118a)) for users to access via a text messaging service or other network service. More specifically, a publisher may be any developer or service provider that provides a service or a product for users. For example, a publisher may be a restaurant owner that creates a textsite to provide information about his/her restaurant.

In one or more embodiments, a user is defined as a person or entity accessing content published by publishers and registered with the global textsite platform (108). As noted above, the published and registered content may be hosted by the global textsite platform (108). In one or more embodiments, a user is a person or entity with a mobile device that does not have a data plan subscription. Rather, the user is able to obtain data using the mobile device only via a TMS. That is, embodiments of the invention pertain specifically to users accessing content only via a TMS. Those skilled in the art will appreciate, however, that although embodiments of the invention target users that communicate via a TMS, the invention is not limited to such users. Specifically, while embodiments of the invention are directed to providing access to textsites to users using a mobile phone via a TMS, some users may be provided with the capability to access content on the global textsite platform (108) via a computing device (128), such as a desktop computer, a laptop computer, a thin computer, a combination thereof, or any other suitable electronic computing device that is capable of connecting to the global textsite platform (108) via the Internet (126). For example, in one or more embodiments, a user may use a text message emulator executing on the computing device (128) to connect to the global textsite platform (108) via the Internet (126). Alternatively, users with smart phones and/or mobile devices that support Internet browsing functionality could access content on the global textsite platform (108) using the Internet (126).

Further as shown in FIG. 1B, a user may possess the user mobile device (102) that is communicatively coupled to the global textsite platform (108) via the telecommunication network (130) and the Internet (126). The user mobile device (102) includes a display (104), a microchip (105), and a TMS input/output module (106). The user mobile device (102) may be any mobile device, such as a Code Division Multiple Access (CDMA) device, a global system mobile (GSM) device, a 3G device, a 4G device, a smart phone, a tablet, a pad device, a gaming device, a personal digital assistant, or any other suitable mobile device that includes text messaging functionality. In one or more embodiments of the invention, the user mobile device (102) is operatively connected to a global textsite platform (108) via a telecommunication network (130). The telecommunication network (130) may be any network that facilitates the exchange of messages from one part of the network to another. For example, the telecommunication network (130) may be a wide area network, a local area network, a public switched telephone network (PSTN), or any other suitable network for exchanging messages between the global textsite platform (108) and the user mobile device (102).

The display (104) of the user mobile device (102) may be a display screen using technology such as liquid crystal display (LCD), a light emitting diode (LED), organic light emitting diode (OLED), or any other suitable type of display screen capable of displaying the content of received text messages and the content of a text message that is being composed on the user mobile device (102). The microchip (105) may be any tangible hardware processor(s) or microprocessor(s) for executing the functionalities of the user mobile device (102). More specifically, the microchip (105) executes the software application(s) that provide functionalities such as browsing, text messaging, maintaining a contact list and making phone calls, etc. The TMS input/output module (106) may be a virtual keyboard, a physical keyboard, or any other input/output device(s) or button(s) that allows the publisher to compose text messages and receive and read text message responses.

In the user system (100b) of FIG. 1B, the global textsite platform (108) is configured to receive a text message from the user mobile device (102) that includes a request to access a textsite hosted by the global textsite platform (108). Further, the global textsite platform (108) is configured to process the request received from the user mobile device (102), and to provide the content from the desired textsite to the user's mobile device (102) via a TMS.

To facilitate this interaction with a user mobile device (102), the global textsite platform (108) includes an agent (115). In one or more embodiments of the invention, the agent (115) may be software that is the component of the global textsite platform (108), which communicates with a user mobile device (102). Specifically, the agent (115) is configured with functionality to receive a text message (i.e., a user message) from a user mobile device (102), parse the text message for the relevant keywords or platform-specific syntax, and respond to the user request by identifying and retrieving the content from the requested textsite/converted website for delivering back to the user mobile device (102) in accordance with one or more embodiments of the invention. In one or more embodiments, the content is delivered to the user mobile device (102) in a text message sent from the global textsite platform (i.e., a GTP message).

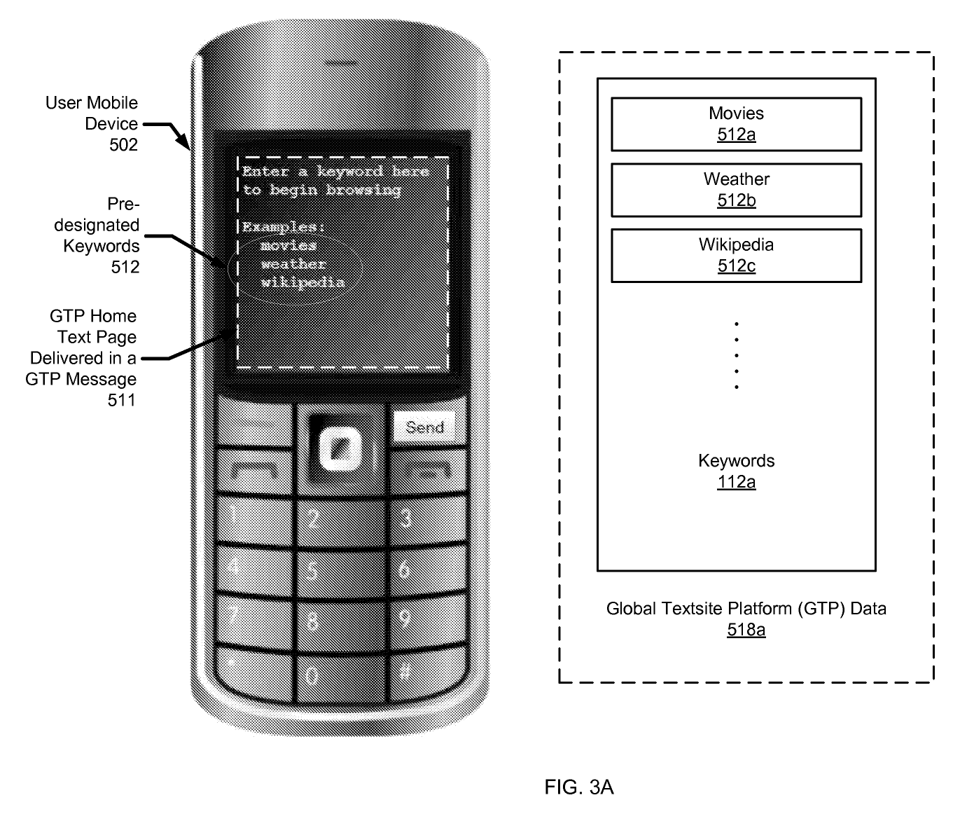

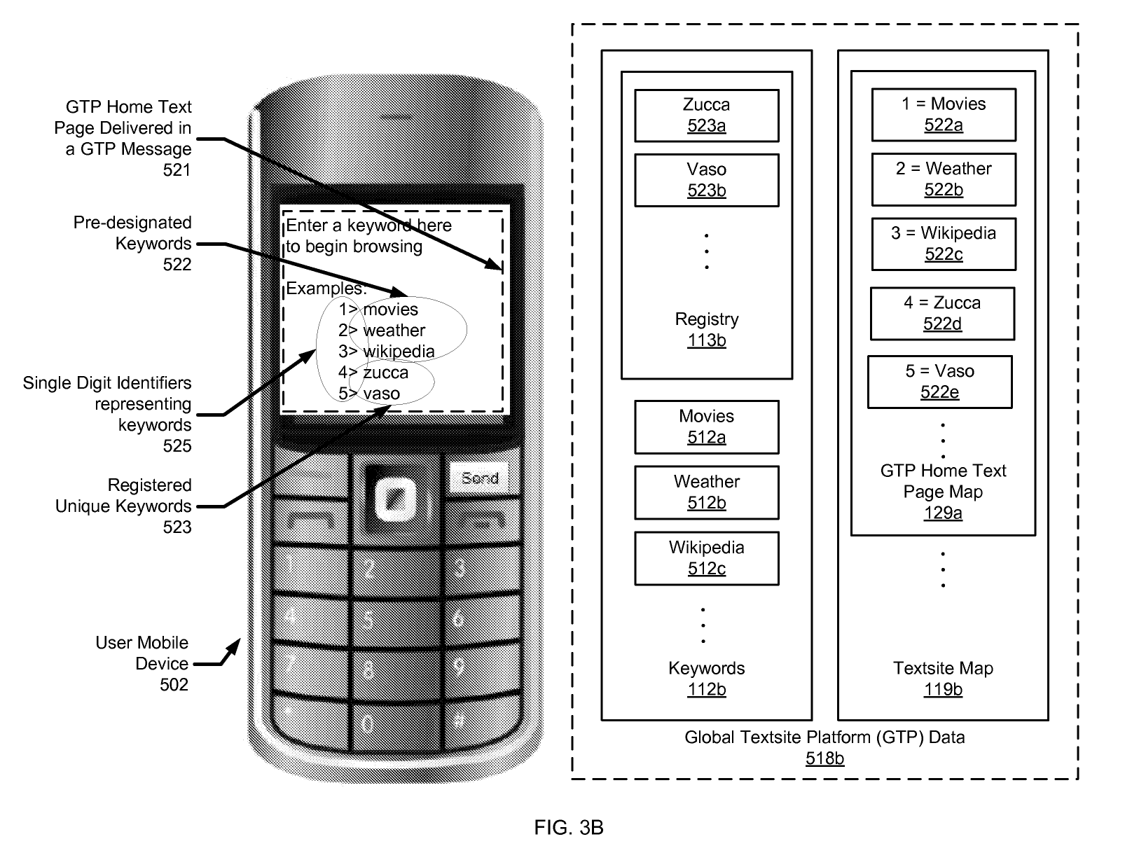

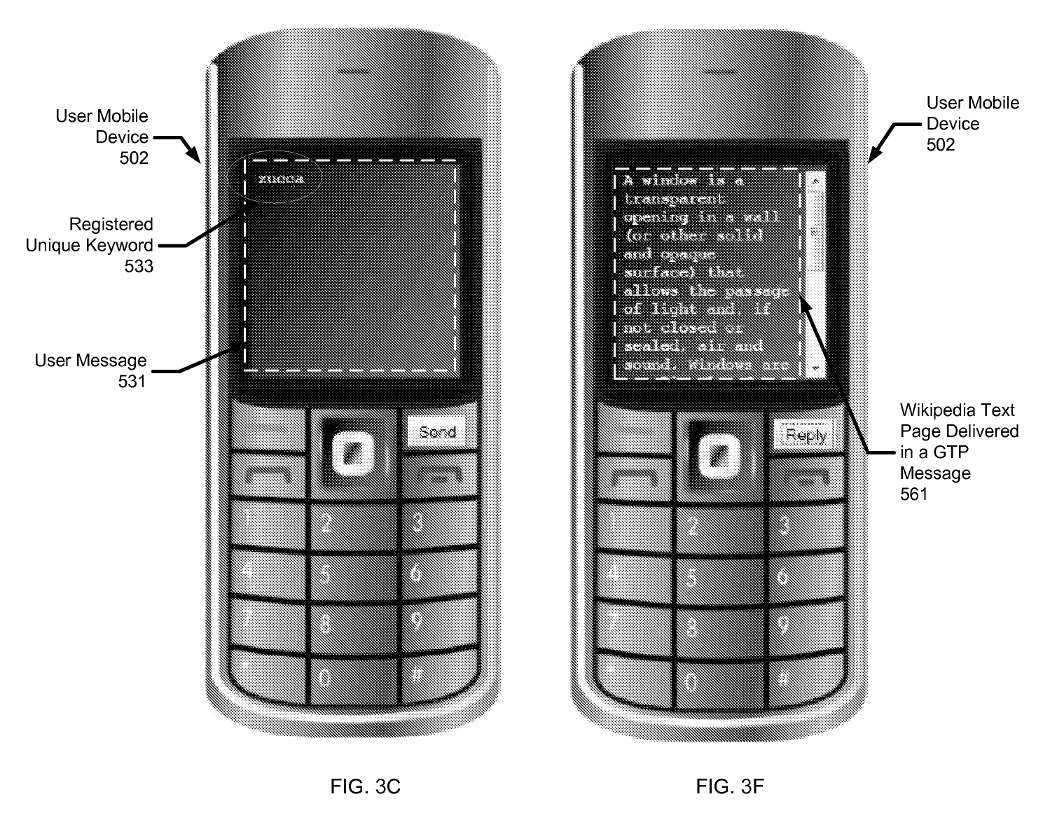

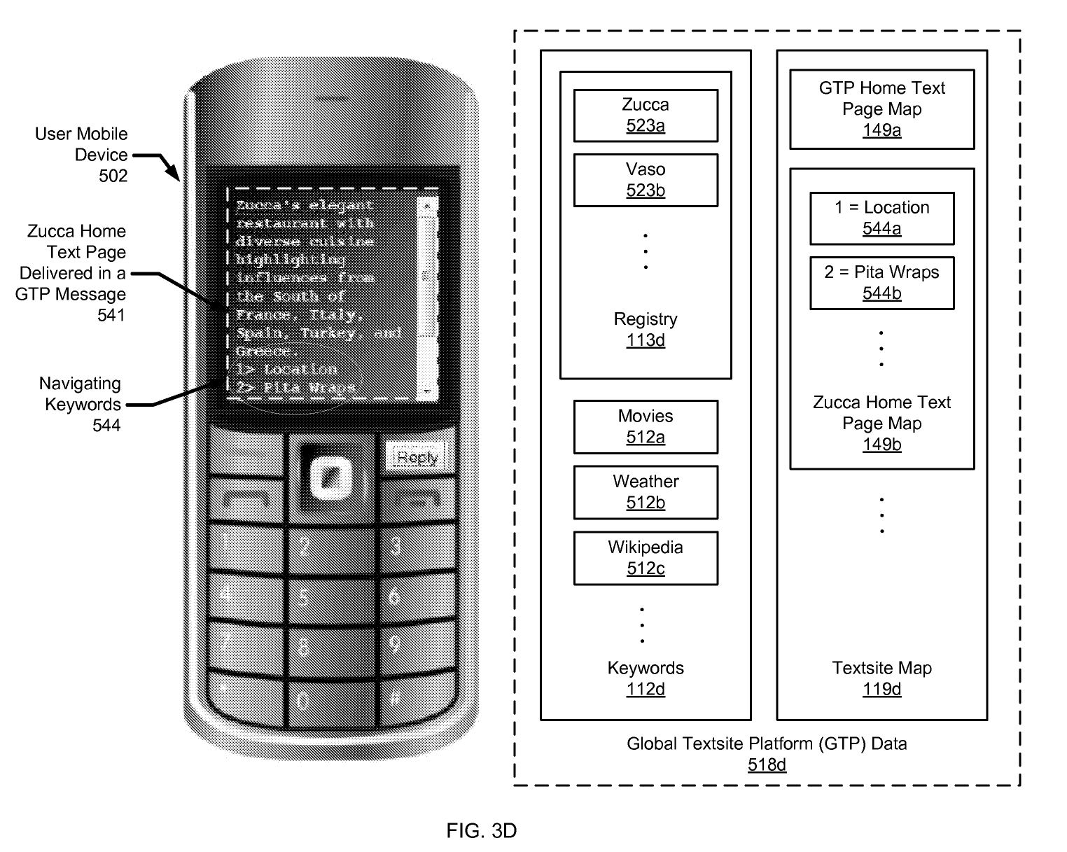

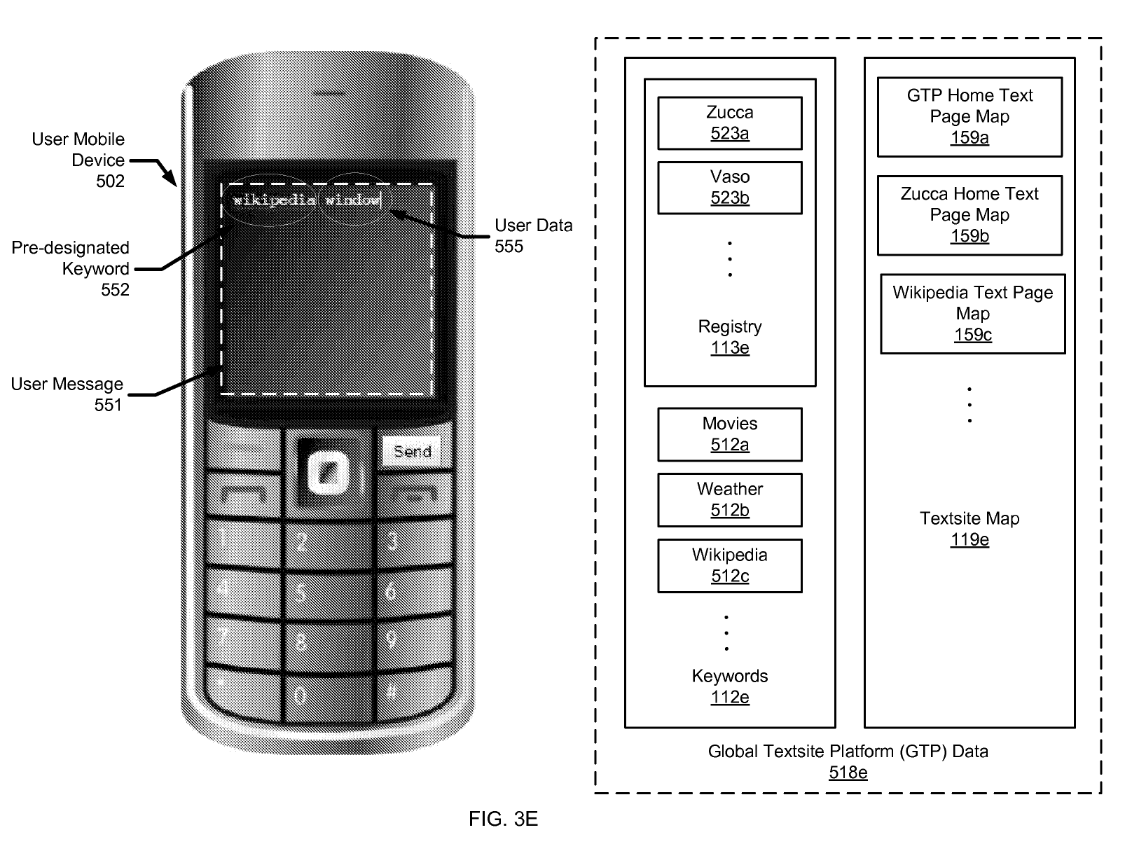

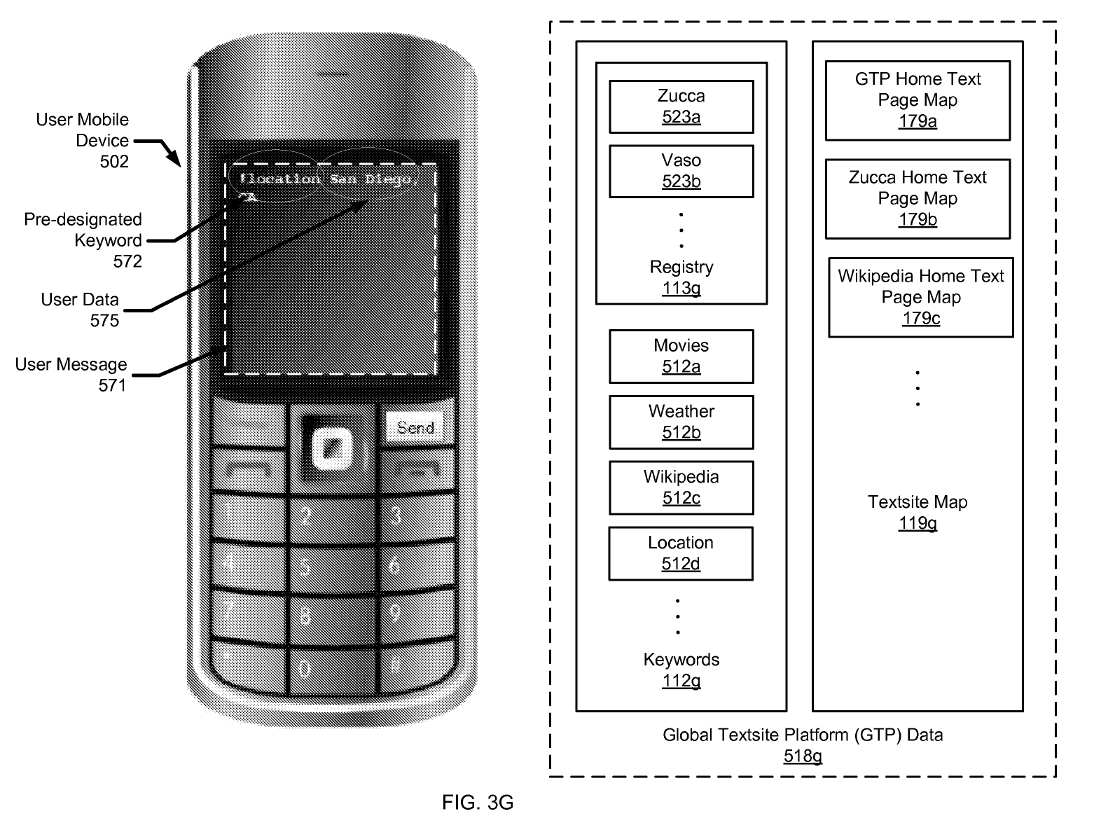

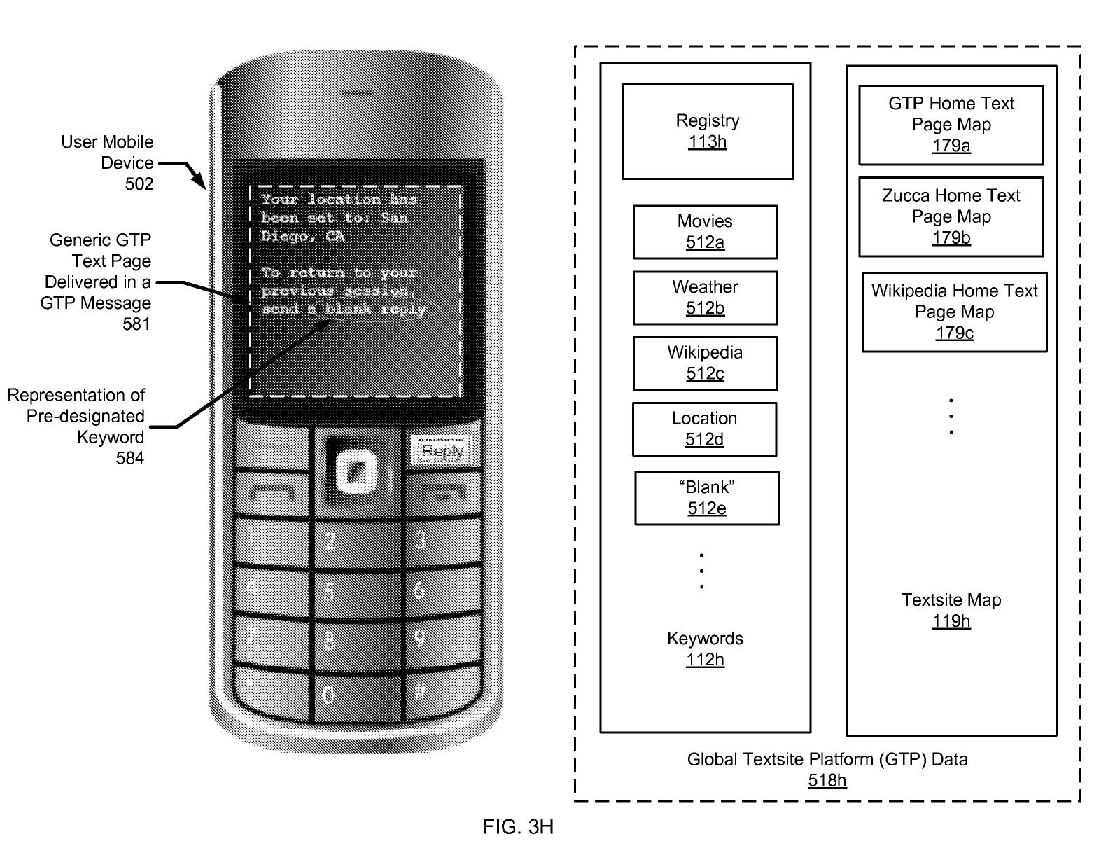

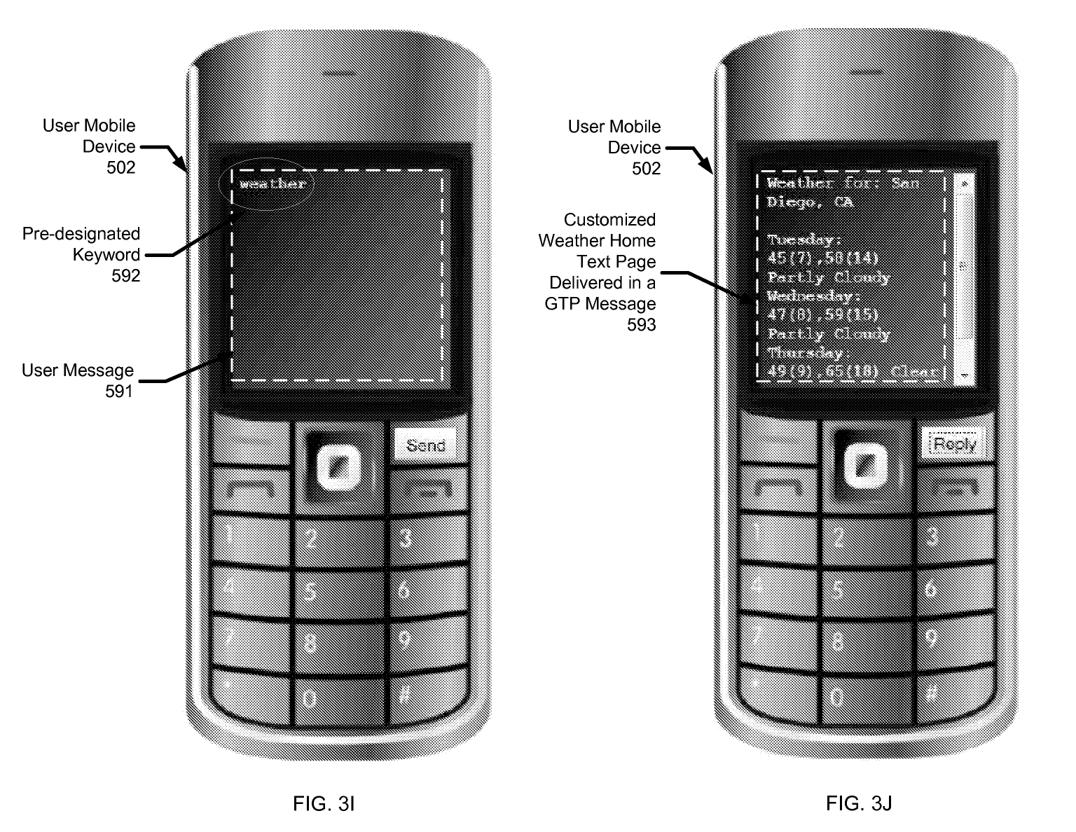

In one or more embodiments of the invention, the agent (115) is configured to identify, based on the registry (113), a registered unique keyword (i.e., used as site identifier) in the user message as a request to access the textsite (118a) hosted on the global textsite platform (108) or the textsite (128a) hosted on the third party server (126a). Accordingly, the agent (115) is configured to access the textsite (118a) or the textsite (128a) using the aforementioned access path included in the associated metadata. In one or more embodiments, the agent (115) is configured to exchange text messages with the user mobile device (102) for navigating a text page hierarchy of the textsite (118a) or the textsite (128a). In one or more embodiments, the textsite (118a) and the textsite (128a) include textsite map (119) and textsite map (129), respectively, that describe the hierarchical relationships of text pages contained within each textsite (118a, 128). For example, the textsite map (119) and the textsite map (129) may each include a data structure (e.g., graph, tree, linked list, file, database, etc.) containing navigating keywords defined by the respective publisher. Generally speaking, navigating keyword information (e.g., access information such as location, address, or other information enabling access to a text page pointed to by a navigating keyword) and navigation paths among text pages in the textsite (e.g., textsite (118a)) are stored in the textsite map (e.g., textsite map (129)). Specifically, a navigation path leads from one text page to another via intervening text pages accessed using the navigating keywords contained in each of the text pages traversed along the navigation path. More details of navigating a textsite, for example based on the textsite map, by exchanging text messages between the agent (115) and the user mobile device (102), are described in reference to FIGS. 3A-3J below.

In one or more embodiments of the invention, the agent (115) is configured to identify, based on the registry (113), a registered unique keyword (i.e., used as site identifier) in the user message as a request to access the website (138) hosted on the web server (136). For example, such registered unique keyword may be registered by a publisher of an adaptor plug-in that maps the website map (139) into a global textsite platform syntax suitable for the adaptor (120) to convert contents of the website (138). Accordingly, the agent (115) is configured to activate the adaptor (120) for accessing the website (138) using the aforementioned access path included in the associated metadata. In one or more embodiments, the agent (115) is configured to exchange text messages with the user mobile device (102) and convert between such text messages in the global textsite platform syntax (e.g., navigating keywords) and the website map (139) for navigating a website document hierarchy of the website (138). For example, the mapping between such navigating keywords and the website map (139) may be contained in an adaptor plug-in for the website (138) where the navigating keywords are defined by the publisher of the adaptor plug-in.

In one or more embodiments of the invention, the agent (115) is configured to identify a web URL (i.e., used as website identifier in Universal Resource Locator format) in the user message as a request to access the website (138) hosted on the web server (136). Accordingly, the agent (115) is configured to activate the adaptor (120) for accessing the website (138) using the identified web URL via the Internet (126). The subsequent navigation of the website (138) may be essentially the same as described above.

In one or more embodiments of the invention, the textsite (118a), the textsite (128a), and/or the website (138) are configured to integrate contents from each other. In such embodiments, the textsite map (119), the textsite map (129), and/or the website map (139) are configured to include registered unique keywords (i.e., used as site identifiers) of other textsites and/or websites, which may be included in user text messages for redirecting the user mobile device (102) from one site (e.g., one of the textsite (118a), the textsite (128a), and the website (138)) to another during navigation of textsite content or converted website content.

In one or more embodiments of the invention, the aforementioned text messages exchanged between the user mobile device (102) and the global textsite platform (108), and more specifically between the user mobile device (102) and the agent (115), are of the same TMS protocol. Alternatively, text messages exchanged may include more than one TMS protocol. For example, the user messages may be SMS and the GTP messages may be MMS. Additional combinations are also possible in other examples.

Although the description above uses the user mobile device (102) in various example embodiments, those skilled in the art will appreciate that similar functionalities may be achieved by substituting the user mobile device (102) with the computing device (128). Further, the aforementioned redirecting functionality may be adapted to allow browsing of website (138) using the computing device (128) to be redirected to accessing a textsite (e.g., textsite (118a) or textsite (128a)) using the user mobile device (102) and vice-versa.

Although the GTP data (e.g., keywords, registry, textsite map, etc.) shown in FIG. 1B above are described in specific formats and organizations, those skilled in the art with the benefit of this disclosure will recognize that GTP data may be in other formats or organizations without deviating from the spirit of the invention.

FIG. 2A shows a flow chart for accessing content during a client server application session in accordance with one or more embodiments of the invention. More specifically, FIG. 2A shows a flow chart describing maintaining session persistence of user data item while accessing content using multiple network protocols. Specifically, the client server application session includes a sequence of activities (e.g., requests and responses) between a user client device and a computer server providing the content. In one or more embodiments of the invention, the method of FIG. 2A may be practiced using the system (100a) and/or system (100b) described in reference to FIG. 1A and/or FIG. 1B above. In one or more embodiments of the invention, one or more of the steps shown in FIG. 2A may be omitted, repeated, and/or performed in a different order than that shown in FIG. 2A. Accordingly, the specific arrangement of steps shown in FIG. 2A should not be construed as limiting the scope of the invention.

Initially in ST 201, during the client server application session, a first request is received from the user client device to access the content using a first network protocol. In particular, the first request itself is sent using the first network protocol. In one or more embodiments, the first network protocol is the HTTP protocol and the first request includes a first user identifier specific to identifying the user client device while using the first network protocol. For example, the user client device may be a smartphone and first user identifier may be a phone number of the smartphone or a code derived (e.g., encrypted) from the phone number.

In ST 202a, in response to receiving the first request, a user data item is generated and included in a user data set of the client server application session. The user data set is referred to as the client server application session user data set.

In one or more embodiments, the content is accessed via an application executing on the computer server, and the user data set is a set of user configuration settings of the application. In other words, the user data item is a user configuration setting of the application. In one or more embodiments, the user data set (e.g., the set of user configuration settings) is tagged with the first user identifier.

In one or more embodiments, the content is stored as a textsite hosted on the computer server, and the user data item is a dynamically assigned link for navigating the textsite. In such embodiments, ST 202a is expanded into ST 202b, which includes ST 203 through 205.

In ST 203, a first navigating keyword is extracted from the first request to identify a first text page of the textsite. For example, the first request is for obtaining the first text page of the textsite and includes the first navigating keyword to identify the requested page. Details of using navigating keyword to navigate the textsite are described in reference to FIGS. 2B-3J below. In one or embodiments, the textsite is organized as a hierarchy of textpages. For example, the first text page may include a second navigating keyword, which in turn identifying a second text page of the textsite.

In ST 204, in response to the extracting the first navigating keyword and subsequent identifying the second navigating keyword, a keyword identifier is assigned to the second navigating keyword. For example, the keyword identifier may be a shorthand identifier to represent the second navigating keyword. Certain TMS protocols impose a limit on total number of text characters that can be transmitted in a single TMS message. Shorthand identifiers allow a user to use less key clicks to input navigating keywords, as well as allow the user client device to transmit less text characters to represent navigating keywords within the TMS protocol imposed total text character limit. Details of keyword identifiers are described in reference to FIGS. 2B-3J below.

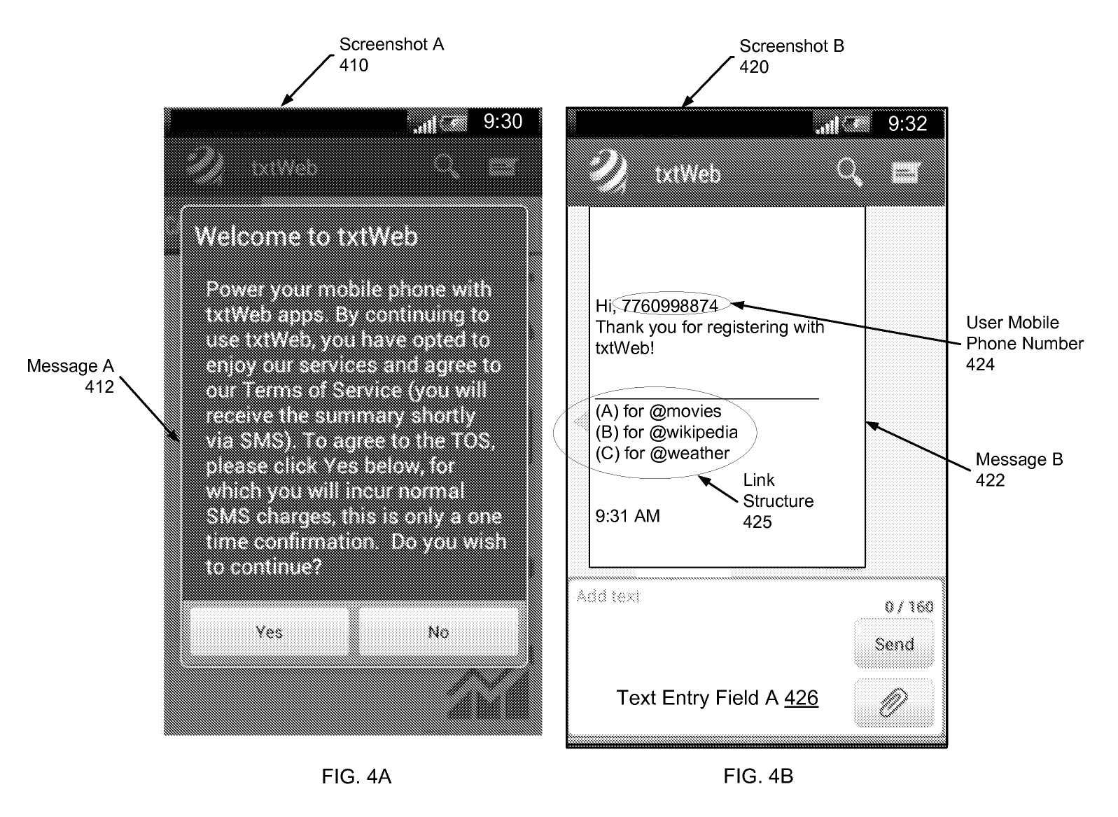

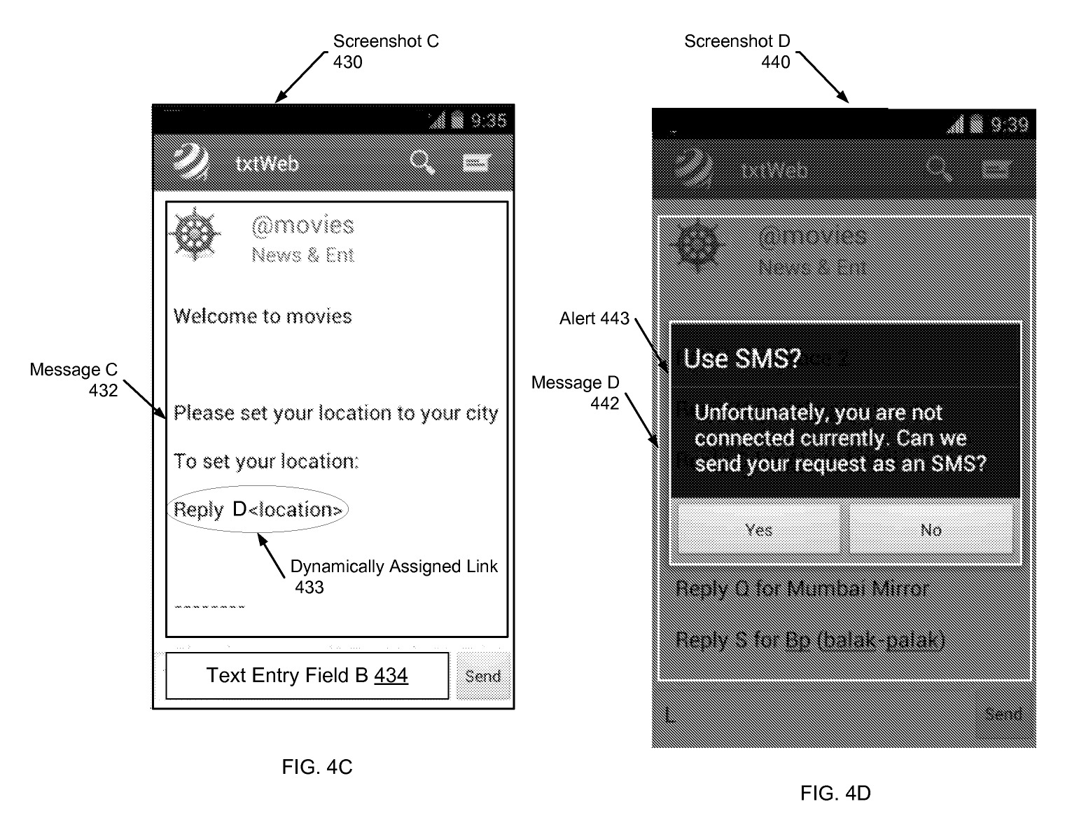

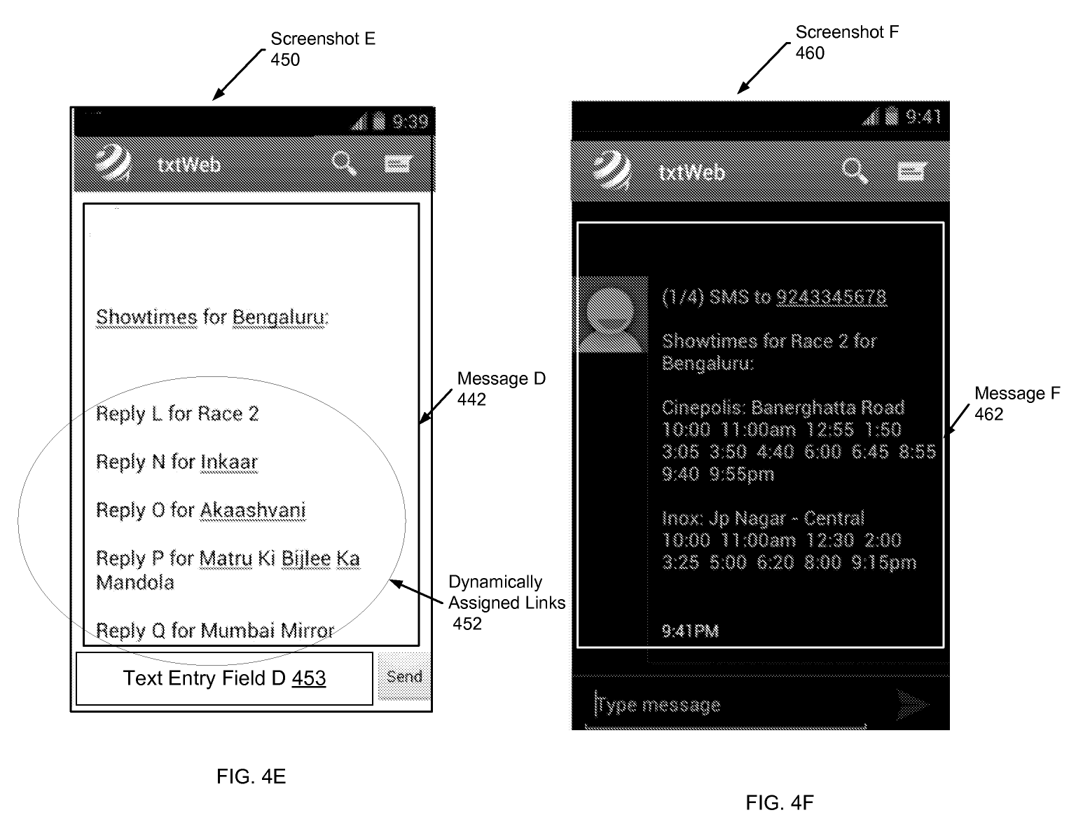

In the context that the keyword identifier is assigned in response to the first request for the first textpage, such assignment is dynamic in the sense that different keyword identifiers may be assigned to the same navigating keyword depending on the context when it is assigned. Accordingly, the assigned keyword identifier is referred to as dynamically assigned keyword identifier. In one or more embodiments, the keyword identifier is a shorthand identifier selected from a fixed pool of text characters (e.g., 26 letters, 36 alphanumeric characters, etc.) and assigned on a rotating basis. Accordingly, navigating keywords contained in a requested textpage are usually assigned random shorthand identifiers depending on the position of the particular requested page in the sequence of multiple requested textpages. An example of assigning shorthand identifiers on a rotating basis is described in reference to FIGS. 4A-4F below. In one or more embodiments, in response to receiving the first request, the user data item is generated as a link between the dynamically assigned keyword identifier and the second navigating keyword. The link is referred to as a dynamically assigned link and includes information describing the association between the dynamically assigned keyword identifier and the second navigating keyword. In one or more embodiments, the user data item is included in a list of dynamically assigned links. Specifically, the user data set of the client server application session includes the list of dynamically assigned links.

In ST 205, further in response to the first request, the first text page is sent to the user client device. In particular, the first text page includes the second navigating keyword and is sent along with an indication that the second navigating keyword is linked to the dynamically assigned keyword identifier. Accordingly, the user viewing the first text page using the user client device is made aware that the dynamically assigned keyword identifier can be used for navigating the textsite. In one or more embodiments, the dynamically assigned keyword identifier is included in a second request by a user to request the second text page.

Following the ST 202a, or the expanded version ST 202b, a network connection event is detected in ST 206. In particular, the detected network event leads to changing the network protocol used for the client server application session. In one or more embodiments, the network connection event is a loss of network connection. For example, subsequent to sending the first request, a connection loss between the client device and the computer server may be detected by the user client device. Specifically, the connection loss is associated with the first network protocol used for the client server application session prior to the connection loss. As a result, the second network protocol is selected, in response to the detecting, by the user client device for sending the second request. In another example, such connection loss is detected by the computer processor. As a result, the computer processor selects the second network protocol for sending the requested content to the user client device as requested by the first request. In response, the user client device selects the second network protocol for sending the second request.

In ST 207, the second request to access the content using a second network protocol is received from the user client device by the computer server. In particular, the second request itself is sent using the second network protocol. For example, the second network protocol may be the TMS protocol via a cellular phone network. In one or more embodiments, the second request includes a second user identifier specific to identifying the user client device while using the second network protocol. As noted above, the user client device may be a smartphone. Similar to the first user identifier, the second user identifier may also be the phone number of the smartphone or a code derived (e.g., encrypted) from the phone number. In one or more embodiments, an association between the first user identifier and the second user identifier is stored in the computer server. For example, the association between the first user identifier and the second user identifier may be stored in the client server application session user data set along with other user data items. In particular, the first user identifier may be derived from the second user identifier, used to derive the second user identifier, or the same as the second user identifier.

In ST 208, the second request is analyzed based on the association between the first user identifier and the second user identifier to obtain the first user identifier. In one or more embodiments, the second request is determined as belonging to the same client server application session as the first request based on this association. Accordingly, the user data item (additionally the client server application session user data set containing the user data item) tagged by the first user identifier is accessible for use by the second request based on the obtained first user identifier.

In ST 209, in response to the analyzing the second request to determine that the user data item and the user data set is accessible for use by the second request, the user data item is retrieved. Specifically, the user data item is identified/selected for retrieval based on the first user identifier.

In ST 210, a portion of the content requested by the second request is provided to the user client device based on the retrieved user data item. In one or more embodiments where the content is accessed via an application and the user data item is an application configuration setting, the requested content for the second request is provided based on this application configuration setting. In one or embodiments where the content is stored as a textsite and the user data item is a dynamically assigned link for navigating the textsite, a keyword identifier included in the second request is extracted and used to obtain a corresponding navigating keyword based on the dynamically assigned link. Accordingly, the second text page is identified as the requested content and provided to the client user device.

FIG. 2B shows a flow chart for accessing content of one or more textsites in accordance with one or more embodiments of the invention. More specifically, FIG. 2B shows a flow chart describing the process for accessing content from the global textsite platform (GTP) perspective, in which the platform provides users (i.e., users accessing content authored by publishers) with access to content maintained in the form of textsites by the GTP. In one or more embodiments of the invention, the method of FIG. 2B may be practiced using the GTP described in reference to FIG. 1B above. In one or more embodiments of the invention, one or more of the steps shown in FIG. 2B may be omitted, repeated, and/or performed in a different order than that shown in FIG. 2B. Accordingly, the specific arrangement of steps shown in FIG. 2B should not be construed as limiting the scope of the invention.

Initially in ST 211, a first user message is received, from a user mobile device that identifies a registered unique keyword maintained by the GTP. As described above, the registered unique keyword may be registered with the GTP by a publisher of a textsite identified by the registered unique keyword while the user device may be a mobile phone or other computing devices. By sending the registered unique keyword in the first user message, the user is requesting access to (i.e., to browse) the textsite associated with the registered unique keyword. In one or more embodiments of the invention, the GTP and/or the publisher may distribute an advertisement containing the registered unique keyword in a commercial promotion. Accordingly, the user may obtain the registered unique keyword from the advertisement. Alternatively, in one or more embodiments of the invention, the GTP may send, in response to receiving a request from the user device, a GTP message identifying a number of sample registered unique keywords from which the user may select a particular one to be included in the first user message. For example, the sample registered unique keywords may be registered with the GTP by a number of different publishers. In one or more embodiments, the request for a listing of registered unique keywords may be received from the user device in a second user message containing a pre-designated keyword defined specifically for requesting such a listing. Alternatively, in one or more embodiments, the user may request such a listing by simply making a conversationless call to the phone number of the GTP instead of sending the second user message to the same phone number. Using any of the approaches described above, the user may obtain a list of textsites accessible via the GTP using a single phone number (e.g., a local phone number) provided by the GTP according to a geographical location of the user. Accordingly, the user is not required to separately obtain and keep different phone numbers for accessing different textsites using a TMS.

In ST 212, authored content (e.g., access information) associated with the textsite requested by the user is retrieved based on the registered unique keyword extracted from the first user message received at the GTP. In one or more embodiments of the invention, the GTP maintains a registry containing an entry for each registered unique keyword that holds pertinent information of the textsite such as location, network address, access path, and other suitable metadata associated with the textsite. Accordingly, the access information associated with the user requested textsite may be retrieved. For example, such access information may determine whether the requested textsite is hosted on a server of the GTP or a third party server separate from the GTP.

In ST 213, the textsite is accessed based on the retrieved authored content (e.g., access information) to retrieve a navigating keyword. For example, a portion of the navigating keywords of the textsite may be retrieved. In another example, the navigating keyword may be retrieved by retrieving a home text page from the textsite that contains the navigating keyword. Generally speaking, the navigating keyword may be an alphanumeric string (e.g., location, Pita Wraps, Panini, Entrees, etc.) that is meaningful to the user but requires many keys to enter into the user device while the other navigating keyword may be a short string (e.g., loc, PW, P, E, 1, 2, 3, etc.) that is easy to enter but less meaningful to the user for selection. To assist the user in selecting a navigating keyword from a GTP message and to key in the selected navigating keyword when composing a reply user message, a cryptic navigating keyword (e.g., loc, PW, P, E, 1, 2, 3, etc.) may be associated with a meaningful label (e.g., location, Pita Wraps, Panini, Entry, etc.) and displayed together (e.g., loc>location, PW>Pita Wraps, P>Panini, E>Entrees, 1>location, 2>Pita Wraps, 3>Panini, etc.) in the text page delivered via the GTP message. Similarly, a meaningful navigating keyword (e.g., location, Pita Wraps, Panini, Entry, etc.) may be associated with a short hand identifier (e.g., loc, PW, P, E, 1, 2, 3, etc.) and displayed together (e.g., loc>location, PW>Pita Wraps, P>Panini, E>Entrees, 1>location, 2>Pita Wraps, 3>Panini, etc.) in the text page delivered via the GTP message. The meaningful label and the short hand identifier are referred to as a representation of the navigating keyword. In one or more embodiments, representations of the navigating keyword may also include formats different from the meaningful label and/or the short hand identifier.

In ST 214, a first GTP message containing the retrieved navigating keyword is sent to the user device in response to receiving the first user message. In one or more embodiments, the first GTP message includes the retrieved portion of the textsite navigating keywords. In one or more embodiments, the first GTP message includes the text page containing the retrieved navigating keyword. For example, the home text page of the textsite may be sent to the user device in the first GTP message as a reply to the first user message containing the registered unique keyword. Accordingly, the user may access a desired text page from the home text page by selecting a corresponding navigating keyword contained in the home text page. In one or more embodiments, a text page also contains, as defined by the publisher, representations of included navigating keywords for ease of user selection. For example, each of the navigating keywords in the home text page sent in the first GDP message may be accompanied by a meaningful label or a short hand identifier. Accordingly, the user may specify (or identify) a desired text page by including either a corresponding navigating keyword or a representation of such navigating keyword in a second user message replying to the first GTP message. In ST 215, this second user message is received at the GTP.

As noted above, navigating keyword information (e.g., access information such as location, address, or other information enabling access to a text page pointed to by a navigating keyword) and navigation paths to text pages in the textsite are stored in the textsite map. In one or more embodiments of the invention, information regarding meaningful labels, short hand identifiers, or other keyword representations for a navigating keyword in a text page is also included in the textsite map. For example, such information includes the aforementioned dynamically assigned link and dynamically assigned keyword identifier described in reference to FIGS. 1A and 2A above. In ST 216, the desired text page is identified according to the textsite map based on either the navigating keyword or a representation (e.g., a meaningful label, short hand identifier) thereof extracted from the second user message. Further, the desired text page is retrieved by looking up access information in the textsite map accordingly.

In ST 217, the desired text page is included in a second GTP message and sent, as reply to the second user message, to the device for display to the user.

In ST 218, a third user message is received from the device while displaying the first text page. The third user message includes a pre-designated keyword (e.g., “,” “0,” .” .,” etc.). For example, the pre-designated keyword may be defined specifically for accessing a home text page of the textsite. In response, the GTP sends the home text page to the device in a third GTP message (ST 219). In another example, the pre-designated keyword may be defined specifically for accessing a previous text page sent to the device prior to the text page in a navigation trace. An example navigation trace is described with reference to FIGS. 3A-3J below. In response, the GTP sends the previous text page to the device in the third GTP message (ST 219). In still another example, the pre-designated keyword may be defined specifically for accessing a forward text page sent to the device subsequent to the text page in the navigation trace. In response, the GTP sends the forward text page to the device in a third GTP message (ST 219). In yet another example, the pre-designated keyword may be defined specifically for subscribing to updates of a currently displayed text page. In response, the GTP sends updated versions of the currently displayed text page in a push mode to the device from time to time in recurring GTP messages (ST 219).

While the description above regarding ST 211 through ST 219 relates to a textsite published by a publisher under a registered unique keyword, the user may obtain another registered unique keyword separately registered with the GTP by another publisher of another textsite. During navigation of the currently displayed textsite, a user message may be received identifying a second registered unique keyword. For example, such user message may include either the second registered unique keyword or a representation thereof. In response, the GTP redirects the user device from the currently navigated textsite to the second textsite (ST 220). Accordingly, the GTP may exchange text messages with the device for navigating the second textsite using a second set of navigating keywords according to a second textsite map of the second textsite. Accordingly, in one or more embodiments, the user may switch back and forth between different textsites published by different publishers without the need to change the phone number to which the text messages are sent in the middle of the textsite navigation.

As described above, there are several different approaches as to how a user may obtain a list of all textsites accessible via the GTP regardless of which publisher authored the content. An additional scenario in which the user may obtain additional registered unique keywords is from a text page having an embedded external link, as authored by the publisher and is consistent with the textsite map. In this scenario, a user message may be redirected to a second or third textsite as described above. Further, the text page may include a short hand identifier for the embedded external link in which case the user message may just include the short hand identifier for quick redirection.

In some scenarios, the second textsite described above is converted from a website, for example, using the adaptor described in reference to FIG. 1B above. In such scenarios, the second navigating keyword may be registered for the website where a corresponding registry entry specifies a particular adaptor plug-in for use to map between a website map of the website and a textsite map converted from the website map. Specifically, a navigating keyword received in a user message during navigation of the converted website is processed using the textsite map, the adaptor plug-in, and the website map to retrieve access information associated with a corresponding webpage. Subsequently, the webpage may be retrieved and converted dynamically (i.e., on demand) into a text page for sending to the user device. Alternatively, a pre-converted text page may be stored and retrieved for sending to the user device (ST 221).

Although the description above with respect to FIGS. 3A through 3J generally refers to messages exchanged between the GTP and the user device as text messages transmitted via TMS, those skilled in the art with the benefit of this disclosure will appreciate that the invention is not intended to be limited to exchanges exclusively in text messages or using a TMS. For example, the GTP may provide functionalities to allow a user switching back and forth between browsing textsites via Internet using a computing device and navigating the textsites via telecommunication network using a mobile phone in a seamless fashion with uninterrupted handovers.

Examples of screen shots detailing what a user text message and a response from the global textsite platform may look like are described in reference to FIGS. 3A-3J below.

FIGS. 3A-3J show various screen shots illustrating examples of accessing content hosted by a global textsite platform in one or more embodiments of the invention. Although FIGS. 3A-3J show implementation examples of embodiments of the invention, those skilled in the art will appreciate that there may be other ways in which to implement embodiments of the invention, and that the example screen shots are not meant to limit the scope of the invention. Throughout FIGS. 3A-3J, a text page delivered in a GTP message and the GTP message delivering the text page may both be referred to using the same reference numerals.

FIG. 3A shows the user mobile device (502) displaying an example GTP home text page, which is delivered via TMS in a GTP message (511). As noted above, this GTP home text page may be sent in the GTP message (511) in response to a request from a user. For example, the user may send a request message in a pre-designated format (e.g., with blank content or with content associated with another pre-designated keyword) using a phone number of the GTP to request the GTP home text page. In another example, the user may have made a conversationless telephone call to the phone number of the GTP to request the GTP home text page. As shown in FIG. 3A, the GTP home text page includes pre-designated keywords (512) listed as movies, weather, and Wikipedia. For example, these pre-designated keywords are stored in the keywords (112a) of GTP data (518a) corresponding to the keywords (112) shown in FIG. 1B above. The keywords (112a) includes pre-designated keyword entries of movies (512a), weather (512b), and Wikipedia (512c) corresponding to sample textsites or generic textsites included in and/or hosted by the GTP.

FIG. 3B shows the user mobile device (502) displaying another example GTP home text page delivered in a GTP message (521), which may be requested and delivered in essentially the same way as the example GTP home text page described in reference to FIG. 3A above. In the example GTP home text page shown in FIG. 3B, the pre-designated keywords (522) are essentially the same as the pre-designated keywords (512) described above while followed by registered unique keywords (523) listed as zucca and vaso. Accordingly, keywords (112b) of the GTP data (518b) include a registry (113b) in addition to the pre-designated keyword entries movies (512a), weather (512b), and wikipedia (512c). As shown, the registry (113b) includes keyword entries zucca (523a) and vaso (523b), which are linked to access information (not shown) to the respective textsites associated with those keywords.

Further as shown in FIG. 3B, short hand identifiers (525) (i.e., 1, 2, 3, 4, and 5) are displayed next to and represent pre-designated keywords (522) and registered unique keywords (523) for user selection in the example GTP home text page delivered in the GTP message (521). For example, zucca and vaso of the registered unique keywords (523) correspond to a restaurant textsite and a bookstore textsite, respectively. As described above, the user may include either the keyword “zucca” or the corresponding short hand identifier “4” when replying to the GTP message (521) to access the restaurant textsite. To facilitate this, a textsite map (119b) of the GTP data (518b) includes GTP home text page map (129a) containing entries (e.g., entry (522a) through entry (522e), etc.) for describing representations of the keywords using the short hand identifiers (525) and for describing access information authored for the respective textsites.

As described above, the registered unique keywords zucca and vaso may be registered with the GTP by the respective restaurant and bookstore owners who created their own textsites or registered by contracted publishers on their behalf. Further, the zucca textsite may be hosted on a server of the GTP while the vaso textsite may be hosted on a third party server separate from the GTP.

FIG. 3C shows the user mobile device (502) displaying an example user message (531) containing the registered unique keyword (533) (i.e., zucca) as selected by the user from the example GTP home text page shown in FIG. 3B above. Alternatively, the registered unique keyword (533) may be obtained by the user from an advertisement distributed, for example, by restaurant zucca in a commercial promotion.

FIG. 3D shows the user mobile device (502) displaying an example home text page of the textsite for restaurant Zucca, which is delivered in a GTP message (541) in response to the user message (531) described above. As shown, the example zucca home text page includes navigating keywords and representations thereof (544) listed as “1>location” and “2>pita wraps.” For example, “1” may be considered the navigating keyword while “location” is the meaningful label. Alternatively, “location” may be considered the navigating keyword while “1” is the short hand identifier. In either case, the aforementioned navigating keywords and representations thereof are displayed together for user selection in the zucca home text page. In the example shown in FIG. 3D, the GTP data (518d) is essentially the same as the GTP data (518b) shown in FIG. 3B above with an additional zucca home text page map (e.g., entry (544a), entry (544b), etc.) included in the textsite map (119d). For example, the GTP home text page map (149a) is essentially the same as the GTP home text page map (129a) shown in FIG. 3B above. As described above, the zucca home text page map (149b) contains entries for describing representations of the navigating keywords using the meaningful labels or short hand identifiers within the zucca home text page and for describing access information for respective text pages referenced by the navigating keywords. For example, including either the navigating keyword or the corresponding representation (i.e., either one of “location” or “1”) in a user message replying to the GTP message (541) results in a text page containing address and driving direction information of the zucca restaurant being identified by the GTP. The address and driving direction information (i.e., the authored content for the text page associated with the navigating keyword (i.e., “location” or “1”) is then delivered to the user mobile device (502) in a subsequent GTP message. As described above, the representation of navigating keywords (544) using meaningful labels or short hand identifiers and the use of navigating keywords (544) to index the respective text pages are applicable only within the displayed text page, which is the zucca home text page, in this instance. Said another way, and as illustrated in FIGS. 3G and 3H below, the keyword “location” or “1” may be associated with different effects when used in a context other than replying to a GTP message delivering the zucca home text page.

FIG. 3E shows the user mobile device (502) displaying an example user message (551) containing the pre-designated keyword (552) (i.e., Wikipedia) as selected by the user from the example GTP home text page shown in FIG. 3B above or otherwise obtained by the user from an advertisement distributed, for example, by an operator of the GTP promoting built-in features of the GTP. As shown in FIG. 3E, the pre-designated keyword (552) (i.e., Wikipedia) is followed by user data (555) (i.e., “window”) in the user message (551) to initiate a search for information relating to user data (555) (i.e., “window”) within the Wikipedia textsite. To facilitate this, textsite map (119e) of the GTP data (518e) includes Wikipedia text page map (159c) describing relevant syntax information applicable to the Wikipedia textsite. For example, the Wikipedia text page map (159c) may relate to a home text page or a text page other than the home text page of the Wikipedia textsite. The GTP home text page map (159a) and Zucca home text page map (159b) are essentially the same as the GTP home text page map (149a) and Zucca home text page map (149b) shown in FIG. 3D above.

FIG. 3F shows the user mobile device (502) displaying an example wikipedia text page delivered in a GTP message (561) responding to the user message (531) described above. As shown, the example wikipedia text page contains search result relating to the user data (555) (i.e., “window”).

FIG. 3G shows the user mobile device (502) displaying an example user message (571) containing the pre-designated keyword (572) (i.e., location, as reflected by the entry location (512d) in keywords (112g) of the GTP data (518g)), for example obtained by the user in a GTP user guide (e.g., online user guide). As shown in FIG. 3E, the pre-designated keyword (572) (i.e., location) is followed by user data (575) (i.e., “San Diego”) in the user message (571) to set a global user location parameter throughout the GTP. Accordingly, for example and as described in FIGS. 3I and 3J below, a textsite registered with the GTP may utilize this global user location parameter set by the user for performing related activities, such as searching for weather information associated with the user location reflected in this global user location parameter. In another example, the textsite may overwrite this global user location parameter by a locally defined location keyword, as described in FIG. 3D above. The GTP home text page map (179a), Zucca home text page map (179b), and Wikipedia home text page map (179c) are essentially the same as the GTP home text page map (159a), Zucca home text page map (159b), and Wikipedia home text page map (159c) shown in FIG. 3E above.

FIG. 3H shows the user mobile device (502) displaying an example GTP text page delivered in a GTP message (581) responding to the user message (571) described above. As shown, the example GTP text page contains confirmation to the user data (575) (i.e., “San Diego”) and navigating tips describing a pre-designated keyword “ ” represented by the word “blank” (584) as reflected by the entry “blank” (512e) in keywords (112h) of the GTP data (518h). Based on the displayed navigating tips, the GTP may identify a previous session (e.g., a previous text page) from a user navigation trace for delivering to the user mobile device (502) upon receiving a user message containing the pre-designated keyword “ ” represented by the word “blank” (584). An example user navigation trace is the sequence of textsites traversed by the user as illustrated in FIGS. 3A through 3G above, which may be tracked by the GTP for assisting user textsite navigation. Other examples of pre-designated navigating keywords or syntax associated with the GTP may include a globally reserved single text digit (e.g., “0”) or text string (e.g., “.”) used for re-directing to a home page of the currently displayed textsite, a forward text page in the user navigation trace, or other pre-defined text pages. Similar to the use of the pre-designated keyword “location” (572), such pre-designated navigating keywords (e.g., “,” “0,” “.,” etc.) may be utilized or overwritten by a textsite based on syntax information defined in a corresponding textsite map by the publisher. The textsite map (119h) is essentially the same as the textsite map (119g) as shown in FIG. 3G above.

FIG. 3I shows the user mobile device (502) displaying an example user message (591) containing the pre-designated keyword (592) (i.e., weather) as selected by the user from the example GTP home text page shown in FIG. 3B above or otherwise obtained by the user from an advertisement distributed, for example, by an operator of the GTP promoting built-in features of the GTP.

FIG. 3J shows the user mobile device (502) displaying an example weather text page maintained by the GTP, which is delivered in a GTP message (593) in response to the user message (591) described above. As shown, the example weather text page illustrate a customized home text page for the weather textsite defined by the global user location parameter described in FIGS. 3G and 3H above.

FIGS. 4A-4F show various screen shots illustrating examples of maintaining session persistence of user data item while accessing content using multiple network protocols from a user client device in one or more embodiments of the invention. Although FIGS. 4A-4F show implementation examples of embodiments of the invention, those skilled in the art will appreciate that there may be other ways in which to implement embodiments of the invention, and that the example screen shots are not meant to limit the scope of the invention.

FIG. 4A shows a screenshot A (410) of a user client device (e.g., a mobile device) connected to a cellular network. In particular, the screenshot A (410) is captured at the beginning of a client server application session between the user client device and a computing platform “txtWeb.” Specifically, the screenshot A (410) includes the message A (412), which is a welcome message requesting the user to accept the terms of service for accessing txtWeb. Upon the user clicking on the “Yes” button, the user client device automatically sends a user identifier (e.g., an encrypted phone number or other identifier of the user client device) to txtWeb to register the client server application session. This registration message is sent using the HTTP protocol requiring a premium data plan of the cellular network. In response, txtWeb allocates a user data set to store any information regarding the registered client server application session. As noted above, this user data set is tagged with the user identifier. Based on a default configuration, this registered client server application session uses the HTTP protocol to access txtWeb.

FIG. 4B shows a screenshot B (420) of the user client device. In particular, the screenshot A (410) shows a home page of a textsite hosted on txtWeb. Specifically, the home page includes the message B (422), which is an acknowledgement message from txtWeb confirming the user registration to accept the terms of service for accessing txtWeb. For example, the terms of service may include HTTP connection bandwidth metering charge arrangement. As shown, the acknowledgement message addresses the user using the unencrypted mobile phone number (424) based on the previously sent user identifier used in the registration process. In addition, the home page includes the link structure (425), which indicates that the shorthand identifiers “A,” “B,” and “C” can be used to represent the navigating keywords “@movies,” “@wikipedia,” and “@weather,” respectively. By entering the shorthand identifier “A” into the text entry field A (426) and clicking the send button, the user client device sends the shorthand identifier “A” to txtWeb computer server using the HTTP protocol. In response, the user client device receives a return message from txtWeb using the HTTP protocol. Specifically, the return message corresponds to movie information since the shorthand identifier “A” represents the navigating keyword “@movies.”

FIG. 4C shows a screenshot C (430) of the user client device displaying the message C (432) returned by txtWeb regarding movie information. In particular, the screenshot C (430) shows a starting page of a movie information service provided by the textsite hosted on txtWeb. Specifically, the starting page includes the message C (432) requesting the user to set a location of interest. As shown, the message C (432) includes the dynamically assigned link (433), which indicates that the shorthand identifier “D” can be used to specify a user entered location as a configuration setting of the movie information service. The use of the shorthand identifier “D” as a syntax element to specify a movie interest location is referred to as the semantic context of the shorthand identifier “D.” The shorthand identifier “D” has been dynamically selected from a pool of 26 letters on a rotation basis after the shorthand identifiers “A,” “B,” and “C” were previously assigned. Accordingly, the semantic context of the shorthand identifier “D” is stored as the dynamically assigned link (433) in the user data set allocated when registering the client server application session shown in FIG. 4A. To illustrate the dynamic nature of the shorthand identifier assignment, consider an alternative scenario if the user would have entered the shorthand identifier “C” instead of “A” into the text entry field A (426) and clicking the send button. Because the shorthand identifier “C” represents the navigating keyword “@weather,” the next available shorthand identifier “D,” selected from the pool of 26 letters on a rotation basis after the shorthand identifiers “A,” “B,” and “C” were previously assigned, would have been assigned to a different navigating keyword associated with the weather page instead of the movie interest location shown in FIG. 4C.

Upon the user entering the shorthand identifier “D” followed by a name of the city “Bengaluru” into the text entry field B (434) and clicking the send button, the user client device sends the text string “D Bengaluru” to txtWeb using the HTTP protocol. In response, txtWeb stores the text string “Bengaluru” as a location parameter (i.e., a configuration setting) of the movie information service. In one or more embodiments, the movie information service provided by txtWeb textsite is an application that allows movie information to be accessed. In such embodiments, the aforementioned user data item includes both the dynamically assigned link (433) containing the semantic context of the shorthand identifier “D” and the configuration setting of “Bengaluru” as a location parameter. As noted above, the use of this user data item persists throughout the entire client server application session regardless the network protocol used. This is illustrated in the following FIGS. 4D-4F.

FIG. 4D shows a screenshot D (440) of the user client device displaying the message D (442) returned by txtWeb in response to receiving the text string “D Bengaluru” as shown in FIG. 4B above. In particular, the HTTP connection is either lost due to network condition or manually turned off by the user. For example, the connection loss may have occurred subsequent to receiving the message D (442) returned by txtWeb, in which case the connection loss may have been detected by the user client device. Because of the detected connection loss, the message D (442) is grayed out and superimposed by the alert (443) informing the user that the HTTP connection has been lost and requesting user permission to use the TMS protocol via the cellular phone network as a back up connection to continue the registered client server application session. Upon the user clicking “Yes” of the alert (443), the user client device switches to use the TMS protocol via the cellular phone network to continue the registered client server application session.

FIG. 4E shows a screenshot E (450) of the user client device displaying the message D (442) previously returned by txtWeb regarding movie information. The screenshot E (450) is captured subsequent to the user clicking “Yes” to the alert (443) as shown in FIG. 4D above. Specifically, the TMS protocol is used to continue the client server application session. In particular, the message D (442) in the screenshot E (450), containing same information as before, is no longer grayed out and shows a movie show time listing generated by the movie information service based on the configuration setting of movie interest location “Bengaluru.” Specifically, the movie show time listing includes the dynamically assigned links (452) indicating that the shorthand identifiers “L,” “N,” “O,” “P,” and “Q” are dynamically assigned to represent the navigation keywords “Race 2,” “Inkaar,” “Akaashvani,” “Matru Ki Bijlee Ka Mandola,” and “Mumbai Mirror,” respectively, which are names of movies. These shorthand identifiers “L,” “N,” “O,” “P,” and “Q” have been dynamically selected from a pool of 26 letters on a random basis after the shorthand identifiers “A,” “B,” “C,” and “D” were previously assigned. Accordingly, the association of these shorthand identifiers to the corresponding navigating keywords are stored as the dynamically assigned links (452) in the user data set allocated when registering the client server application session shown in FIG. 4A. In this example, because these shorthand identifiers “L,” “N,” “O,” “P,” and “Q” are selected from the pool of 26 letters on a random basis, the same navigating keywords of these movie names “Race 2,” “Inkaar,” “Akaashvani,” “Matru Ki Bijlee Ka Mandola,” and “Mumbai Mirror” may be assigned different shorthand identifiers next time when the user registers another client application session to browse the movie information. In another example, when the user registers another client application session to browse the movie information in a different city, these shorthand identifiers “L,” “N,” “O,” “P,” and “Q” are to be assigned to different movie name navigating keywords depending on what may be showing in the movie theaters of this different city.

Note that prior to the HTTP connection loss or switching off by the user, the dynamically assigned link (433) containing the semantic context of the shorthand identifier “D,” the configuration setting of “Bengaluru” as the movie location parameter, as well as these shorthand identifiers “L,” “N,” “O,” “P,” and “Q” dynamically assigned to represent the navigation keywords of movie names are all user data items generated when the HTTP connection is used and tagged with the user identifier associated with the HTTP connection. As illustrated in the screenshot E (450), subsequent to the user client device switching to use the TMS protocol via the cellular phone network to continue the registered client server application session, these previously generated user data items persist throughout the client server application session regardless of which network protocol is being used. In other words, they continue to take effect during the continued portion of the registered client server application session when the TMS protocol is used. Upon the user entering the shorthand identifier “L” into the text entry field D (453) and clicking the send button, the user client device sends the shorthand identifier “L” to txtWeb using the TMS protocol via the cellular phone network connection. In response, txtWeb returns the message F (462) using the TMS protocol via the cellular phone network connection.

FIG. 4F shows a screenshot F (460) of the user client device displaying the message F (462) returned by txtWeb server regarding the movie show times of the movie “Race 2” that is represented by the dynamically assigned shorthand identifier “L.”

Embodiments of the invention may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 5, the computing system (600) may include one or more computer processor(s) (602), associated memory (604) (e.g., random access memory (RAM), cache memory, flash memory, etc.), one or more storage device(s) (606) (e.g., a hard disk, an optical drive such as a compact disk (CD) drive or digital versatile disk (DVD) drive, a flash memory stick, etc.), and numerous other elements and functionalities. The computer processor(s) (602) may be an integrated circuit for processing instructions. For example, the computer processor(s) may be one or more cores, or micro-cores of a processor. The computing system (600) may also include one or more input device(s) (610), such as a touchscreen, keyboard, mouse, microphone, touchpad, electronic pen, or any other type of input device. Further, the computing system (600) may include one or more output device(s) (608), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device. The computing system (600) may be connected to a network (612) (e.g., a local area network (LAN), a wide area network (WAN) such as the Internet, mobile network, or any other type of network) via a network interface connection (not shown). The input and output device(s) may be locally or remotely (e.g., via the network (612)) connected to the computer processor(s) (602), memory (604), and storage device(s) (606). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (600) may be located at a remote location and connected to the other elements over a network (612). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for accessing content during a client server application session, comprising:
receiving, during the client server application session and from a user client device, a first request to access the content using a first network protocol, wherein the first request comprises a first user identifier;
generating, in response to receiving the first request and by a processor of a computer server storing the content, a user data item for including in a user data set of the client server application session, wherein the user data set is tagged with the first user identifier;
receiving, during the client server application session and from the user client device, a second request to access the content using a second network protocol, wherein the second request comprises a second user identifier;
analyzing, by the computer processor and based on an association between the first user identifier and the second user identifier, the second request to obtain the first user identifier;
retrieving, by the computer processor and in response to the analyzing, the user data item from the user data set based on the first user identifier; and
providing, in response to receiving the second request and by the computer processor to the client device, a requested portion of the content based on the user data item.

2. The method of claim 1,
wherein the content is accessed via an application executing on the computer server,
wherein the user data set comprises a plurality of user configuration settings of the application, and
wherein the user data item comprises a user configuration setting of the plurality of user configuration settings.

3. The method of claim 1,
wherein the content is stored as a textsite hosted on the computer server, and
wherein the user data item comprises a dynamically assigned link for navigating the textsite.

4. The method of claim 1,
wherein the content is stored as a textsite hosted on the computer server, and
wherein generating the user data item comprises:
extracting a first navigating keyword from the first request to identify a first text page of the textsite, wherein the first text page comprises a second navigating keyword identifying a second text page of the textsite; and
assigning, in response to the extracting and identifying, a keyword identifier to the second navigating keyword, wherein the user data item comprises a link between the keyword identifier and the second navigating keyword.

5. The method of claim 4, further comprising:
sending, to the user client device and in response to the first request, the first text page comprising the second navigating keyword and an indication that the second navigating keyword is linked to the keyword identifier, and
wherein the keyword identifier is include in the second request by a user to request the second text page, and
wherein providing the requested portion of the content comprises:
extracting the keyword identifier from the second request;
obtaining the second navigating keyword based on the keyword identifier and the user data item; and
identifying the second text page as the requested portion of the content.

6. The method of claim 1,
wherein the user client device detects, subsequent to sending the first request, a connection loss between the client device and the computer server,
wherein the connection loss is associated with the first network protocol, and
wherein the second network protocol is selected, in response to the detecting, by the user client device for sending the second request.

7. The method of claim 1, further comprising:
receiving, by the computer processor and subsequent to receiving the first request, an indication of a connection loss between the client device and the computer server, wherein the connection loss is associated with the first network protocol; and
selecting, by the computer processor and in response to receiving the indication, the second network protocol for sending a portion of the content requested by the first request to the user client device,
wherein the second network protocol is selected, in response to receiving the portion of the content in the second network protocol, by the user client device for sending the second request.

8. The method of claim 1,
wherein the first network protocol comprises a HTTP protocol, and
wherein the second network protocol comprises a text messaging service (TMS) protocol.

9. The method of claim 1,
wherein the first user identifier is at least one selected from a group consisting of derived from the second user identifier, used to derive the second user identifier, and the same as the second user identifier.

10. The method of claim 1,
wherein the first request is sent by the user client device using the first network protocol, and
wherein the second request is sent by the user client device using the second network protocol.

11. A system accessing content during a client server application session, comprising:
a repository storing the content and a user data set of the client server application session;
a processor; and
memory storing instructions when executed by the processor comprising functionalities to:
receive, during the client server application session and from a user client device, a first request to access the content using a first network protocol, wherein the first request comprises a first user identifier;
generate, in response to receiving the first request, a user data item for including in the user data set, wherein the user data set is tagged with the first user identifier;
receive, during the client server application session and from the user client device, a second request to access the content using a second network protocol, wherein the second request comprises a second user identifier;
analyze, based on an association between the first user identifier and the second user identifier, the second request to obtain the first user identifier;
retrieve, in response to the analyzing, the user data item from the user data set based on the first user identifier; and
provide, in response to receiving the second request and to the client device, a requested portion of the content based on the user data item.

12. The system of claim 11,
wherein the content is accessed via an application executing on the computer server,
wherein the user data set comprises a plurality of user configuration settings of the application, and
wherein the user data item comprises a user configuration setting of the plurality of user configuration settings.

13. The system of claim 11,
wherein the content is stored as a textsite hosted on the computer server, and
wherein the user data item comprises a dynamically assigned link for navigating the textsite.

14. The system of claim 11,
wherein the content is stored as a textsite hosted on the computer server,
wherein generating the user data item comprises:
extracting a first navigating keyword from the first request to identify a first text page of the textsite, wherein the first text page comprises a second navigating keyword identifying a second text page of the textsite; and
assigning, in response to the extracting and identifying, a keyword identifier to the second navigating keyword, wherein the user data item comprises a link between the keyword identifier and the second navigating keyword,
wherein the instructions, when executed, further comprise functionality to:
send, to the user client device and in response to the first request, the first text page comprising the second navigating keyword and an indication that the second navigating keyword is linked to the keyword identifier,
wherein the keyword identifier is include in the second request by a user to request the second text page, and
wherein providing the requested portion of the content comprises:
extracting the keyword identifier from the second request;
obtaining the second navigating keyword based on the keyword identifier and the user data item; and
identifying the second text page as the requested portion of the content.

15. The system of claim 11,
wherein the user client device detects, subsequent to sending the first request, a connection loss between the client device and the computer server,
wherein the connection loss is associated with the first network protocol, and
wherein the second network protocol is selected, in response to the detecting, by the user client device for sending the second request.

16. The system of claim 11, wherein the instructions, when executed, further comprise functionality to:
receive, subsequent to receiving the first request, an indication of a connection loss between the client device and the computer server, wherein the connection loss is associated with the first network protocol; and
select, in response to receiving the indication, the second network protocol for sending a portion of the content requested by the first request to the user client device,
wherein the second network protocol is selected, in response to receiving the portion of the content in the second network protocol, by the user client device for sending the second request.

17. The system of claim 11,
wherein the first network protocol comprises a HTTP protocol, and
wherein the second network protocol comprises a text messaging service (TMS) protocol.

18. The system of claim 11,
wherein the first user identifier is at least one selected from a group consisting of derived from the second user identifier, used to derive the second user identifier, and the same as the second user identifier.

19. The system of claim 11,
wherein the first request is sent by the user client device using the first network protocol, and
wherein the second request is sent by the user client device using the second network protocol.

20. A non-transitory computer readable storage medium comprising software instructions for accessing content during a client server application session, that when executed, comprise functionality to:
receive, during the client server application session and from a user client device, a first request to access the content using a first network protocol, wherein the first request comprises a first user identifier;
generate, in response to receiving the first request, a user data item for including in a user data set of the client server application session, wherein the user data set is tagged with the first user identifier;
receive, during the client server application session and from the user client device, a second request to access the content using a second network protocol, wherein the second request comprises a second user identifier;
analyze, based on an association between the first user identifier and the second user identifier, the second request to obtain the first user identifier;
retrieve, in response to the analyzing, the user data item from the user data set based on the first user identifier; and
provide, in response to receiving the second request, a requested portion of the content based on the user data item.
